(19) United States
(12) Patent Application Publication
(10) Pub. No.: US 2025/0286729 A1
(43) Pub. Date: Sep. 11, 2025

(54) DATA PROCESSING METHOD AND APPARATUS BASED ON TRUSTED EXECUTION ENVIRONMENT, DEVICE, AND MEDIUM

(71) Applicant: TENCENT TECHNOLOGY (SHENZHEN) COMPANY LIMITED, Shenzhen (CN)

(72) Inventor: Qucheng LIU, Shenzhen (CN)

(21) Appl. No.: 19/213,741

(22) Filed: May 20, 2025

Related U.S. Application Data
(63) Continuation of application No. PCT/CN2023/131626, filed on Nov. 14, 2023.

(30) Foreign Application Priority Data
Apr. 27, 2023 (CN) 202310479511.5

(51) Int. Cl. H04L 9/32; H04L 9/08

(52) U.S. Cl. CPC H04L 9/3247; H04L 9/0825; H04L 9/0869; H04L 9/3231

(57) ABSTRACT

A data processing method and apparatus based on a trusted execution environment includes: transmitting object data encryption information obtained through encryption based on a first communication key and a to-be-signed service to a key custody client when remote attestation performed by a resource management client on the key custody client succeeds, so that the key custody client performs remote signing processing on the to-be-signed service by using a custodial key fragment when obtaining object access data information through decryption based on the first communication key; obtaining a first key fragment based on the object access data information when service remote signature information returned by the key custody client is received, and performing local signing processing on the to-be-signed service, to obtain service local signature information; and writing the to-be-signed service into a blockchain based on the service remote signature information and the service local signature information.

### CROSS-REFERENCES TO RELATED APPLICATIONS

This application is a continuation of PCT Application No. PCT/CN2023/131626, filed on Nov. 14, 2024, which claims priority to Chinese Patent Application No. 202310479511.5, filed with the China National Intellectual Property Administration on Apr. 27, 2023 and entitled “DATA PROCESSING METHOD AND APPARATUS BASED ON TRUSTED EXECUTION ENVIRONMENT, DEVICE, AND MEDIUM”, the entire contents of all of which are incorporated herein by reference.

### FIELD OF THE TECHNOLOGY

The present disclosure relates to the field of computer technologies, and in particular, to a data processing method based on a trusted execution environment, a data processing apparatus based on a trusted execution environment, a computer device, a computer-readable storage medium, and a computer program product.

### BACKGROUND OF THE DISCLOSURE

For a service terminal (for example, a user terminal) integrated with a resource management client, most used key storage solutions are centralized key custody schemes. The centralized key custody scheme specifically means that service objects (for example, a user A and a user B) individually (or centrally) store their own keys in a custodial device corresponding to a third-party custodian by using corresponding service terminals (for example, user terminals).

For the foregoing centralized key custody scheme, when a service object (for example, a user A) needs to use a key (for example, a key Y) of the service object to perform service signing on a service (for example, a service Tx1) currently obtained by the service object, when the user A accesses a resource management client, service signing may be directly performed on the service by using the key (for example, the key Y) of the user A stored by a custodial device, and service signature information obtained after the service signing is returned to the resource management client accessed by the user A. Because the custodial device is configured to individually (or centrally) store keys of different users, when an illegal user illegally accesses the custodial device, keys individually (or centrally) stored in the custodial device are lost in batches. In this case, it is difficult for the resource management client accessed by the user A to determine whether the key of the user A used in the signing process of the service Tx1 is a valid key. In other words, in the currently used centralized key custody scheme, it is difficult to ensure security of a user key custodied by a third party.

### SUMMARY

Embodiments of the present disclosure provide a data processing method and apparatus based on a trusted execution environment, a device, and a medium, to ensure security of a key fragment used in a service signing process, thereby improving reliability of service on-chaining.

An aspect of the embodiments of the present disclosure provides a data processing method based on a trusted execution environment, where the method is performed by a resource management client, and the method includes: performing remote attestation on a key custody client deployed in the trusted execution environment when a service object accesses the resource management client by using object access data information, obtaining a first communication key by performing key exchange processing with the key custody client, and in response to the remote attestation succeeds, performing encryption processing on the object access data information by using the first communication key, to obtain object data encryption information; transmitting, in response to obtaining a to-be-signed service transmitted by the service object, the object data encryption information and the to-be-signed service to the key custody client based on a first threshold signature policy corresponding to the to-be-signed service, so that the key custody client decrypts the object data encryption information by using the first communication key to obtain the object access data information, performs identity verification on the service object based on the object access data information, and when the identity verification succeeds, performs remote signing processing on the to-be-signed service by using a custodial key fragment stored in the key custody client, to obtain service remote signature information of the to-be-signed service; obtaining a first key fragment of the service object based on the object access data information when the service remote signature information returned by the key custody client is received, and performing local signing processing on the to-be-signed service by using the first key fragment, to obtain service local signature information of the to-be-signed service; and determining a first accumulated signature quantity of the to-be-signed service based on the service remote signature information and the service local signature information, and when the first accumulated signature quantity reaches an accumulated signature threshold indicated by the first threshold signature policy, using the to-be-signed service as a signed service to be written into a blockchain, and transmitting the signed service to a blockchain node, wherein the signed service is written into the blockchain by the blockchain node into the blockchain.

An aspect of the embodiments of the present disclosure provides a data processing method based on a trusted execution environment, where the method is performed by a key custody client, and the key custody client is deployed in the trusted execution environment. The method includes: receiving a to-be-signed service and object data encryption information that is transmitted by a resource management client based on a first threshold signature policy corresponding to the to-be-signed service; the object data encryption information being obtained after the resource management client performs encryption processing on object access data information by using a first communication key; the first communication key being obtained by the resource management client by performing key exchange processing with the key custody client when the resource management client performs remote attestation on the key custody client and the remote attestation succeeds; and the object access data information being entered by a service object when accessing the resource management client; decrypting the object data encryption information based on the first communication key to obtain the object access data information, performing identity verification on the service object based on the object access data information, and when the identity verification succeeds, performing remote signing processing on the to-be-signed service by using a custodial key fragment stored in the key custody client, to obtain service remote signature information of the to-be-signed service; and transmitting the service remote signature information to the resource management client, so that the resource management client obtains a first key fragment of the service object based on the object access data information, and performs local signing processing on the to-be-signed service by using the first key fragment, to obtain service local signature information of the to-be-signed service; and when the resource management client determines a first accumulated signature quantity of the to-be-signed service based on the service remote signature information and the service local signature information, and the first accumulated signature quantity reaches an accumulated signature threshold indicated by the first threshold signature policy, uses the to-be-signed service as a signed service to be written into a blockchain, and transmits the signed service to a blockchain node.

An aspect of the embodiments of the present disclosure provides a data processing apparatus based on a trusted execution environment, where the apparatus runs on a resource management client and includes: a remote attestation module, configured to: perform remote attestation on a key custody client deployed in the trusted execution environment when a service object accesses the resource management client by using object access data information, obtain a first communication key by performing key exchange processing with the key custody client, and in response to the remote attestation succeeds, perform encryption processing on the object access data information by using the first communication key, to obtain object data encryption information; a service transmitting module, configured to transmit, in response to obtaining a to-be-signed service transmitted by the service object, the object data encryption information and the to-be-signed service to the key custody client based on a first threshold signature policy corresponding to the to-be-signed service, so that the key custody client decrypts the object data encryption information based on the first communication key to obtain the object access data information, performs identity verification on the service object based on the object access data information, and when the identity verification succeeds, performs remote signing processing on the to-be-signed service by using a custodial key fragment stored in the key custody client, to obtain service remote signature information of the to-be-signed service; a local signing processing module, configured to obtain a first key fragment of the service object through decryption by using the object access data information when the service remote signature information returned by the key custody client is received, and perform local signing processing on the to-be-signed service by using the first key fragment, to obtain service local signature information of the to-be-signed service; and a service on-chaining module, configured to: determine a first accumulated signature quantity of the to-be-signed service based on the service remote signature information and the service local signature information, and when the first accumulated signature quantity reaches an accumulated signature threshold indicated by the first threshold signature policy, use the to-be-signed service as a signed service to be written into a blockchain, and transmit the signed service to a blockchain node, wherein the signed service is written into the blockchain by the blockchain node into the blockchain.

An aspect of the embodiments of the present disclosure provides a data processing apparatus based on a trusted execution environment. The apparatus runs on a key custody client, and the key custody client is deployed in the trusted execution environment. The apparatus includes: a service receiving module, configured to receive a to-be-signed service and object data encryption information that is transmitted by a resource management client based on a first threshold signature policy corresponding to the to-be-signed service; the object data encryption information being obtained after the resource management client performs encryption processing on object access data information by using a first communication key; the first communication key being obtained by the resource management client by performing key exchange processing with the key custody client when the resource management client performs remote attestation on the key custody client deployed in the trusted execution environment and the remote attestation succeeds; and the object access data information being entered by a service object when accessing the resource management client; a remote signing processing module, configured to: decrypt the object data encryption information based on the first communication key to obtain the object access data information, perform identity verification on the service object based on the object access data information, and when the identity verification succeeds, perform remote signing processing on the to-be-signed service by using a custodial key fragment stored in the key custody client, to obtain service remote signature information of the to-be-signed service; and a remote signature information transmitting module, configured to transmit the service remote signature information to the resource management client, so that the resource management client obtains a first key fragment of the service object through decryption based on the object access data information, and performs local signing processing on the to-be-signed service by using the first key fragment, to obtain service local signature information of the to-be-signed service; and when the resource management client determines a first accumulated signature quantity of the to-be-signed service based on the service remote signature information and the service local signature information, and the first accumulated signature quantity reaches an accumulated signature threshold indicated by the first threshold signature policy, uses the to-be-signed service as a signed service to be written into a blockchain, and transmits the signed service to a blockchain node.

An aspect of the embodiments of the present disclosure provides a computer device, including: a memory and a processor, the memory being connected to the processor, the memory being configured to store a computer program, and the processor being configured to invoke the computer program, so that the computer device performs the data processing method based on a trusted execution environment in the embodiments of the present disclosure.

An aspect of the embodiments of the present disclosure provides a non-transitory computer-readable storage medium. The computer-readable storage medium stores a computer program. The computer program is adapted to be loaded and executed by a processor, so that a computer device having the processor performs the data processing method based on a trusted execution environment in the embodiments of the present disclosure.

In the embodiments of the present disclosure, when the service object accesses the resource management client by using object access data information, remote attestation may be performed on the key custody client deployed in the trusted execution environment by using the resource management client. When the remote attestation succeeds, the first communication key that is obtained by performing key exchange processing with the key custody client is obtained, and encryption processing is performed on the object access data information by using the first communication key, to obtain the object data encryption information. As can be seen, the resource management client includes the first key fragment, that is, the first key fragment may be stored in the resource management client. When obtaining a to-be-signed service transmitted by the service object, the resource management client may transmit the object data encryption information and the to-be-signed service to the key custody client based on a first threshold signature policy corresponding to the to-be-signed service, so that the key custody client decrypts the object data encryption information based on the first communication key to obtain the object access data information, performs identity verification on the service object based on the object access data information, and when the identity verification succeeds, performs remote signing processing on the to-be-signed service by using a custodial key fragment stored in the key custody client, to obtain service remote signature information of the to-be-signed service. As can be seen, the key custody client stores the custodial key fragment. That is, in the embodiments of the present disclosure, key fragments are deployed on different client terminals (for example, the first key fragment may be stored on the resource management client, and the custodial key fragment may be stored on the key custody client deployed in the trusted execution environment). In this way, security of key storage can be ensured. In addition, the resource management client may obtain the first key fragment of the service object based on the object access data information when the service remote signature information returned by the key custody client is received, and perform local signing processing on the to-be-signed service by using the first key fragment, to obtain the service local signature information of the to-be-signed service. As can be seen, in the embodiments of the present disclosure, different key fragments (for example, the first key fragment stored in the resource management client, and the custodial key fragment stored in the key custody client) deployed on different client terminals may be configured for performing common signing during a service signing process, which can improve reliability of a service signature. In addition, in the embodiments of the present disclosure, the key custody client is deployed in the trusted execution environment, to resolve, from a root point, a problem of illegal leakage of a custodial key fragment caused by a loss of a key custody device held by a third-party custodian. The first accumulated signature quantity of the to-be-signed service is determined based on the service remote signature information and the service local signature information, and when the first accumulated signature quantity reaches the accumulated signature threshold indicated by the first threshold signature policy, the to-be-signed service is used as a signed service to be written into the blockchain, and the signed service is transmitted to the blockchain node, wherein the signed service is written into the blockchain by the blockchain node into the blockchain. As can be seen, by using a threshold signature policy (herein, a policy in which a user and a third-party custodian may jointly participate in performing cooperative signing), a current service (that is, a to-be-signed service) may be determined as a signed service depending on a plurality of pieces of signature information that reaches an accumulated signature threshold (for example, two), and further the signed service may be written into the blockchain by using the blockchain node, to ensure reliability of service on-chaining.

### BRIEF DESCRIPTION OF THE DRAWINGS

FIG. 1 is a schematic diagram of a system architecture according to an embodiment of the present disclosure.

FIG. 2 is a schematic diagram of a data exchange scenario according to an embodiment of the present disclosure.

FIG. 3 is a data processing method based on a trusted execution environment according to an embodiment of the present disclosure.

FIG. 4 is a schematic diagram of a remote attestation scenario according to an embodiment of the present disclosure.

FIG. 5 is a schematic diagram of a user registration procedure scenario according to an embodiment of the present disclosure.

FIG. 6 is an interaction timing diagram for developing, reviewing, and installing a resource management client according to an embodiment of the present disclosure.

FIG. 7 is an interaction sequence diagram for developing, reviewing, installing, and remote attestation of a trusted application according to an embodiment of the present disclosure.

FIG. 8 is a schematic flowchart of a data processing method based on a trusted execution environment according to the present disclosure.

FIG. 9 is an interaction flowchart of performing remote attestation according to an embodiment of the present disclosure.

FIG. 10 is a schematic diagram of a scenario in which multi-party threshold signature is performed according to an embodiment of the present disclosure.

FIG. 11 is a schematic diagram of a scenario in which signature record flow information is searched for according to an embodiment of the present disclosure.

FIG. 12 is a process sequence diagram of a data processing method based on a trusted execution environment according to an embodiment of the present disclosure.

FIG. 13 is a schematic structural diagram of a data processing apparatus based on a trusted execution environment according to the present disclosure.

FIG. 14 is a schematic structural diagram of a data processing apparatus based on a trusted execution environment according to the present disclosure.

FIG. 15 is a schematic structural diagram of a computer device according to the present disclosure.

FIG. 16 is a schematic diagram of a data processing system based on a trusted execution environment according to an embodiment of the present disclosure.

### DESCRIPTION OF EMBODIMENTS

1. Trusted execution environment (TEE): The trusted execution environment is a secure region on a computing platform, and may be constructed by using a software and/or hardware method, to ensure that code and data loaded in the secure region are protected in terms of confidentiality and integrity. An objective of the trusted execution environment is to ensure that a task is executed as expected, to ensure security and integrity of an initial state of the task, and security and integrity of a running state of the task. Actually, the trusted execution environment may be understood as a technology based on hardware protection data and an algorithm, and is an isolated environment of a processor and a memory. Only a central processing unit (CPU) can access an application program in the trusted execution environment, and access by other layers (such as other hardware, a kernel, and another application program) to the trusted execution environment is blocked by the CPU. In the embodiments of the present disclosure, application programs deployed and running in the trusted execution environment may be collectively referred to as a trusted client (or a trusted application).

Both a server configured to provide a key custody service and a server configured to provide a signature record query service run in a trusted execution environment (that is, a TEE). The server configured to provide the key custody service and the server configured to provide the signature record query service that are involved in the embodiments of the present disclosure may be the same server, or may be different servers. This is not limited herein.

An example in which the server configured to provide the key custody service and the server configured to provide the signature record query service are the same server is used. In the embodiments of the present disclosure, the server configured to provide the key custody service and the server configured to provide the signature record query service may be collectively referred to as a business service device. A trusted client (that is, a trusted application) deployed in a trusted execution environment (that is, a TEE) of the same business service device may include at least a key custody client and a log recording client.

The key custody client may be configured to provide a key custody service. For example, by using the key custody service provided by the key custody client, some key fragments (which may also be referred to as local key fragments; for example, the local key fragment herein may be specifically a custodial key fragment) that a service object (for example, a user A) requests to custody are stored into a trusted enclave custody of the key custody client, to ensure storage security of some key fragments (that is, custodial key fragments) stored in the trusted enclave custody of the key custody client. In the embodiments of the present disclosure, in the business service device, a trusted enclave custody that is divided for a service object (for example, a user A) and that is configured for storing a custodial key fragment is referred to as a user private region for the service object (for example, the user A). The custodial key fragment stored in the user private region is visible only to a CPU configured to access the key custody client, and is invisible to a key custody object (that is, a third-party custodian) corresponding to the business service device. This means that the custodial key fragment cannot be invoked by any other process or any software except the CPU that can access the key custody client. In other words, the custodial key fragment stored in the trusted enclave custody of the key custody client can defend against snooping or modification of any other software (for example, an operating system (OS), a basic input/output system (BIOS), a virtual machine manager (VMM), and the like). In this way, security and reliability of the custodial key fragment stored in the trusted execution environment can be ensured from a root point.

The log recording client may be configured to provide a signature record query service, for example, with the signature record query service provided by the log recording client, it may be queried whether flow information obtained after the business service device performs service signing for a service (for example, Tx1) exists. In the embodiments of the present disclosure, flow information obtained after service signing is performed on a service (for example, Tx1) by using the log recording client may be collectively referred to as signature record flow information (or a service log). The flow information is: a list or a record recording all service activities within a period of time. For example, the signature record flow information is a list or a record recording a service signing procedure for the service (for example, Tx1). In an implementation, the log recording client may store the signature record flow information by using a trusted log memory in the log recording client. The business service device may provide a signature self-verification function by using signature record flow information (or a service log) for a service (for example, Tx1) stored in the trusted log memory of the log recording client. The signature self-verification function herein may be understood as: if signature record flow information (or a service log) of the service (for example, Tx1) exists in the trusted log memory, determining that a key custody object (that is, a third-party custodian) to which the business service device belongs indeed performs service signing processing on the service (for example, Tx1) by using the foregoing custodial key fragment (that is, the third-party custodian participates in signing of the service). On the contrary, if signature record flow information (or a service log) of the service (for example, Tx1) does not exist in the trusted log memory, it may be determined that the key custody object (that is, the third-party custodian) corresponding to the business service device does not perform service signing processing on the service (for example, Tx1) by using the foregoing custodial key fragment (that is, the third-party custodian does not participate in signing of the service). Similarly, the signature record flow information stored in the trusted log memory of the log recording client can also defend against snooping or modification of any other software (for example, an operating system (OS), a basic input/output system (BIOS), a virtual machine manager (VMM), and the like). In this way, security and reliability of the signature record flow information stored in the trusted execution environment can be ensured from a root point, so that an effective signature self-verification function can be provided for the third-party custodian by using the signature record flow information with security and reliability.

In the embodiments of the present disclosure, execution environments run by the foregoing trusted client may be collectively referred to as a trusted execution environment or a TEE environment.

2. Intel software guard extensions (Intel SGX, SGX for short): is a group of security-related extended instruction sets, and is built into an Intel central processing unit (CPU) of the sixth generation and later. It allows a particular memory region (for example, the foregoing trusted enclave custody or the foregoing trusted log memory) to be set as a user private region, and this region is also referred to as an enclave. Content (for example, the foregoing custodial key fragment or the foregoing signature record flow information) in the enclave is protected, and cannot be accessed by any process outside the enclave, including operating systems such as a virtual machine manager (VMM), a BIOS, and the like that run at a higher privilege level. The SGX focuses on providing a trusted execution environment (TEE) for a user application. A developer may place a part of code that needs to be protected on the application program (for example, the foregoing key custody client or the foregoing log recording client) in an enclave of the SGX for execution, thereby improving security during running of the application program.

The SGX may be configured to provide the following features: 1) Confidentiality and integrity, that is, code and data in an enclave can defend against snooping or modification of any other software, including privileged software OS, BIOS, and VMM. 2) Remote attestation: The remote attestation refers to a process in which an enclave and a third party that is not on an SGX platform prove each other. The remote attestation in the embodiments of the present disclosure refers to a process in which whether an enclave running environment of an application program has an SGX hardware protection capability and a part of protected code and data of the application program is not tampered with may be authenticated, and after the remote attestation is completed, a key (for example, a communication key obtained through key exchange processing in a remote attestation process), identity information, and other sensitive data of the application program are provided to the enclave. In the embodiments of the present disclosure, the key exchange processing refers to key negotiation, that is, a process in which two (or more) parties negotiate a common key through interaction. 3) Attack surface minimization, that is, the boundary of the CPU is a trust boundary of the SGX, and the SGX only trusts data within the boundary of the CPU, and the data is encrypted when leaving the CPU. In this way, for a business service device on which the foregoing trusted execution environment is deployed, data stored in an enclave is encrypted and invisible even to a third-party key custodian to which the business service device belongs.

3. Blockchain: A blockchain is a new application mode of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network services, the information being configured for verifying the validity of information of the data block (anti-counterfeiting) and generating a next data block. The blockchain may include a blockchain underlying platform, a platform product service layer, and an application service layer. The blockchain includes a series of blocks that are consecutive in a sequence of generation time. Once a new block is added to the blockchain, the new block is no longer removed. The block records record data packed and submitted by a blockchain node in a blockchain system.

In the embodiments of the present disclosure, aggregated signature information obtained after performing multi-party signing on a service (for example, Tx1) and the service (for example, Tx1) on which multi-party signing is performed are transmitted to a blockchain node by using a decentralized, traceable, and non-tamperable feature of the blockchain, so that the blockchain node performs signature verification by using the aggregated signature information, and adds the service (for example, Tx1) as a valid service to a service pool as a valid service, so that the service (for example, Tx1) may be subsequently packaged to a target block in the service pool, and the target block obtained through packaging is on-chained to a blockchain maintained by the blockchain node.

Exemplarily, in the embodiments of the present disclosure, when data such as object access data information, object registration data information, a to-be-signed service, and signature record flow information of a service object (that is, a user) is obtained, a prompt interface or a pop-up window may be displayed. The prompt interface or the pop-up window is configured for prompting the user that data such as object access data information, object registration data information, a to-be-signed service, and signature record flow information is currently being collected by the user. After an operation for confirming the prompt interface or the pop-up window is obtained, the user starts to perform a related operation of data obtaining. Otherwise, the operation ends.

All data (such as object access data information of a service object, object registration data information, a to-be-signed service, and signature record flow information) collected or obtained in the embodiments of the present disclosure is collected or obtained with the consent and authorization of a corresponding service object (such as the foregoing user A). That is, when the embodiments of the present disclosure are applied to a specific product or technology, a user's individual permission or consent needs to be obtained, and related data collection, use, and processing need to comply with relevant laws and standards.

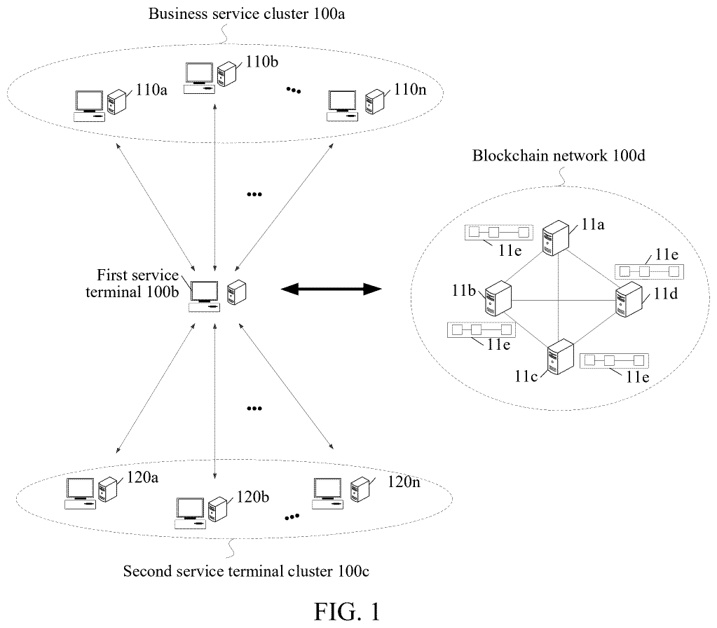

FIG. 1 is a schematic diagram of a system architecture according to an embodiment of the present disclosure. As shown in FIG. 1, the system architecture may include a business service cluster 100a, a first service terminal 100b, a second service terminal cluster 100c, and a blockchain network 100d.

The business service cluster 100a may include one or more key custody devices, and the one or more key custody devices may be configured to store the same custodial key fragment. A quantity of key custody devices in the business service cluster 100a is not limited herein. As shown in FIG. 1, a plurality of key custody devices in the business service cluster 100a may include a key custody device 110a, a key custody device 110b, . . . , and a key custody device 110n. The key custody devices (for example, the key custody device 110a, the key custody device 110b, . . . , and the key custody device 110n) may be connected to the first service terminal 100b shown in FIG. 1 through a network, so as to exchange data with the first service terminal 100b through the network connection, to implement multi-party cooperative signing for a current service.

A key custody device (for example, the key custody device 110a) selected from the business service cluster 100a may be used as the foregoing business service device. The key custody device provides the foregoing key custody service and the foregoing signature record query service, and other key custody devices (for example, the key custody device 110b, . . . , and the key custody device 110n) other than the business service device (for example, the key custody device 110a) in the business service cluster 100a may be used as backup key custody devices.

A service priority of the business service device involved in this embodiment of the present disclosure is higher than a service priority of the backup key custody device. The service priority may be understood as an order in which different key custody devices provide services. A key custody device with a higher service priority preferentially performs data exchange with the service object, so that the key custody device with a higher service priority preferentially provides a service to the service object. To avoid a single point of failure of a single key custody device (for example, the key custody device 110a shown in FIG. 1), an embodiment of the present disclosure provides that a custodial key fragment may be securely and reliably backed up and stored by using one or more backup key custody devices running in a trusted execution environment. In other words, the custodial key fragment stored in the key custody client that is run in the TEE of the business service device is consistent with the custodial key fragment stored in the key custody client that is run in the TEE of the backup key custody device. Therefore, when a key custody device (for example, the key custody device 110a) selected from the business service cluster 100a is used as the foregoing business service device, the business service device may preferentially perform data exchange with the first service terminal 100b based on the foregoing service priority.

For example, when a trusted execution environment deployed in a current business service device (for example, the key custody device 110a) is a secure execution environment, and a key custody client deployed in the secure execution environment is a trusted client, a first service signature request transmitted by a service object (for example, a user A) for a current service (that is, a to-be-signed service) is preferentially received by using the key custody client running in the current business service device (for example, the key custody device 110a). The first service signature request may be transmitted by the service object (for example, the user A) by using a resource management client running in the first service terminal 100b. In this way, when the key custody client is in an offline state because the key custody device 110a has a single point of failure (for example, the device is in an offline state or the device is in a lost state), the business service cluster 100a may continue to select a backup key custody device (for example, the key custody device 110b shown in FIG. 1) from the foregoing backup key custody devices (for example, the key custody device 110b, . . . , and the key custody device 110n) as a new business service device. When a trusted execution environment deployed in the new business service device is a secure execution environment, and a key custody client deployed in the secure execution environment is a trusted client, the first service signature request resent by the foregoing service object (for example, user A) is obtained.

In this embodiment of the present disclosure, the first service terminal 100b shown in FIG. 1 may be referred to as an online terminal or an online device. An application client running on the online terminal (or the online device) may be specifically the foregoing resource management client. The resource management client herein may also be referred to as a resource client. The resource client may be configured to implement a resource management service function, and may implement a communication connection to a decentralized application client based on the resource management service function. The resource management service function herein may include but is not limited to: a resource transfer function, a resource query function, a resource destruction function, and the like. This is not limited in this embodiment of the present disclosure. In one or more implementations, the decentralized application may be an application initiating the foregoing to-be-signed service. The decentralized application associated with the service object involved herein may be integrated with the resource management client (that is, the resource client) to run on the same service terminal (for example, the foregoing first service terminal 100b), or may run on different service terminals. This is not limited herein.

In one or more implementations, the resource client (that is, the resource management client) may also be a tool for managing and storing a digital resource of a user. For example, the digital resource may be transferred to another account based on the resource client. For another example, a digital resource transferred by another account may be received based on the resource client. The resource client may be a hardware device or may be a software program. A function played by a service terminal corresponding to another resource client in the second service terminal cluster 100c is similar to that played by the first service terminal 100b shown in FIG. 1, and details are not described herein again.

The second service terminal cluster 100c may include one or more second service terminals, and the second service terminal may be a service terminal associated with the foregoing service object (for example, the user A). In this embodiment of the present disclosure, the one or more second service terminals deployed in the second service terminal cluster may be collectively referred to as an offline terminal. A quantity of second service terminals (that is, offline terminals or offline devices) deployed in the second service terminal cluster 100c is not limited herein. As shown in FIG. 1, a plurality of second service terminals (that is, offline terminals or offline devices) in the second service terminal cluster 100c may include a second service terminal 120a, a second service terminal 120b, . . . , and a second service terminal 120n.

When the key custody devices deployed in the business service cluster 100a are not available, a second service terminal (that is, an offline terminal) in the second service terminal 120a, the second service terminal 120b, . . . , and the second service terminal 120n shown in FIG. 1 may exchange data with the first service terminal 100b (that is, the online terminal) shown in FIG. 1 in a wireless or wired connection manner, to implement another multi-party cooperative signing for a current service.

The blockchain network 100d shown in FIG. 1 may include a plurality of blockchain nodes (that is, consensus nodes participating in accounting on a blockchain). A quantity of blockchain nodes in the blockchain network 100d is not limited herein. As shown in FIG. 1, the plurality of blockchain nodes in the blockchain network 100d may specifically include a blockchain node 11a, a blockchain node 11b, a blockchain node 11c, and a blockchain node 11d. As shown in FIG. 1, the first service terminal 100b may be connected to the blockchain node 11a, the blockchain node 11b, the blockchain node 11c, and the blockchain node 11d through a network, to perform data exchange with a blockchain node in the blockchain network 100d in a case that the first service terminal 100b accesses the blockchain network 100d. For example, the first service terminal 100b may write, in a multi-party threshold signature manner, the service object request and the signed service into a blockchain maintained by these blockchain nodes. The so-called multi-party threshold signature may be equivalently considered as multi-party cooperative signing, which specifically means that in a service signing process, two or more different devices may be configured for cooperatively implementing service signing. Exemplarily, the multi-party threshold signature (or multi-party cooperative signing) manner involved in this embodiment of the present disclosure specifically means that in a service signing process, two key fragments deployed in different devices may be configured for cooperatively implementing service signing. For example, service signing may be performed on a current service by using a local key fragment (that is, a custodial key fragment) stored by a key custody client deployed in a trusted execution environment of a business service device (such as the foregoing key custody device 110a), to obtain service signature information (such as service signature information 1) of the service, and the service signing may be performed on the current service by using another local key fragment (that is, an online key fragment) stored in an online terminal (that is, the first service terminal 100b) in encryption, to obtain another service signature information (such as service signature information 2) of the service. In this case, the online device (that is, the first service terminal 100b) involved in this embodiment of the present disclosure may write the current service into the blockchain shown in FIG. 1 based on collected service signature information (that is, the foregoing service signature information 1 and service signature information 2) that is obtained by signing by application clients in different devices. The blockchain may be specifically a blockchain 11e maintained by a blockchain node deployed in the blockchain network 100d. The threshold signature policy is a policy of multi-party threshold signature. The threshold signature policy may be configured for indicating how to perform multi-party cooperative signing. For example, the threshold signature policy may indicate an accumulated signature threshold. The accumulated signature threshold is configured for indicating a total quantity of pieces of signature information needed for service signing, that is, indicating a quantity of key fragments needed for cooperative signing for a service. In this embodiment of the present disclosure, the threshold signature policy is a policy that a user and a third-party custodian may participate in cooperative signing.

The blockchain network 100d in this embodiment of the present disclosure may have a layered structure, or may have a single-layer structure. A specific structure of the blockchain network 100d is not limited herein.

In this embodiment of the present disclosure, when the key custody client is in an offline state (that is, the key custody client stops providing the key custody service) because the business service device is unavailable (for example, a service fault occurs), service signing may be cooperatively implemented by using another two key fragments deployed in different devices (for example, an online device and an offline device).

For ease of understanding, in this embodiment of the present disclosure, the first service terminal 100b (that is, an online terminal or an online device) and the second service terminal (that is, an offline terminal or an offline device) in the second service terminal cluster 100c may be collectively referred to as a service terminal associated with the service object. When a first service terminal (that is, an online terminal or an online device) is lost, in this embodiment of the present disclosure, a second service terminal may be selected from the second service terminal cluster 100c as a new first service terminal (that is, a new online terminal), to perform, by using the new online terminal, data exchange with the key custody device that is selected from the foregoing business service cluster and that is used as a business service device.

In this embodiment of the present disclosure, a service terminal on which a resource management client is integrated and run may include: an intelligent terminal such as a smartphone, a tablet computer, a notebook computer, a desktop computer, a wearable device (such as a smartwatch or a smart band), a smart home, a head-mounted device, or an intelligent vehicle. The business service device integrated with a key custody client may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

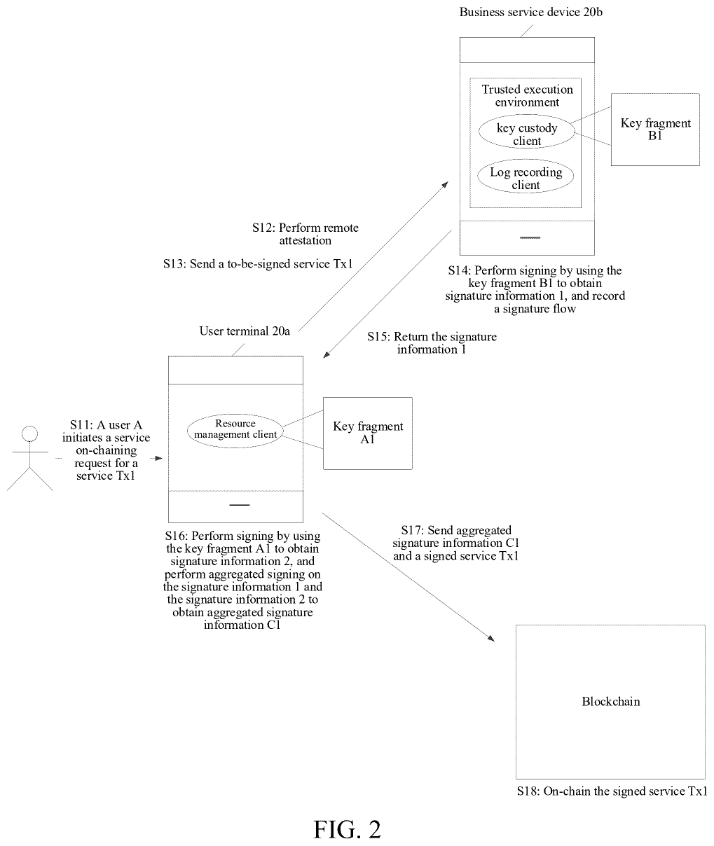

FIG. 2 is a schematic diagram of a data exchange scenario according to an embodiment of the present disclosure. A user terminal 20a shown in FIG. 2 may be the online device in the embodiment corresponding to FIG. 1. A resource management client is integrated and runs in the user terminal 20a. The resource management client is configured to store a local key fragment (for example, a key fragment A1) of a user A (that is, a service object) shown in FIG. 2. Similarly, a business service device 20b shown in FIG. 2 may be the business service device integrated with the key custody client and the log recording client in the embodiment corresponding to FIG. 1.

As shown in FIG. 2, when performing operation S11 shown in FIG. 1 by using a decentralized application, the user A may initiate a service on-chaining request for a service (for example, a service Tx1 shown in FIG. 2) to the resource management client shown in FIG. 2. The user terminal 20a may obtain, from the received service on-chaining request, the service Tx1 initiated by the user A, use the service Tx1 as a to-be-signed service Tx1 (that is, a to-be-signed service), and perform operation S12 shown in FIG. 2, to transmit a remote attestation request to the business service device 20b shown in FIG. 2. When the user terminal 20a determines that the remote attestation on the business service device 20b is completed (that is, the remote attestation succeeds), operation S13 may be performed. That is, in this case, the user terminal 20a may perform encryption processing on object access data information (for example, a user password) by using a communication key L1 (that is, a first communication key), to transmit the object data encryption information and the to-be-signed service Tx1 that are obtained after the encryption processing to the business service device 20b. The communication key L1 may be obtained by performing key exchange processing between the user terminal 20a and the business service device 20b in the remote attestation process. The object access data information is obtained by the user terminal 20a when accessing a resource management client. When a business server obtains the object access data information (for example, the user password) through decryption by using the communication key L1 (that is, the first communication key), the user A may be authorized, by using the object access data information (for example, the user password) obtained through decryption, to obtain the local key fragment (for example, a key fragment B1 shown in FIG. 2) from a trusted enclave custody corresponding to the key custody client, and operation S14 shown in FIG. 2 may be performed. In this case, the business service device 20b may perform service signing on the to-be-signed service Tx1 by using the key fragment B1, to obtain the service signature information 1 of the to-be-signed service Tx1, and may return the service signature information 1 to the user terminal 20a by performing operation S15.

As shown in FIG. 2, a log recording client is deployed in a trusted execution environment of a business server 20b. After a key custody client in the business server 20b performs service signing on the signed service Tx1 by using the key fragment B1, signature recording may be performed on the signature information 1 generated in a service signing process by using the log recording client to obtain a signature flow, and the signature flow is added to the trusted log memory corresponding to the log recording client, so as to subsequently determine, by using the signature flow stored in the trusted log memory, whether a third-party custodian corresponding to the business service device 20b really participates in service signing for the to-be-signed service Tx1. That is, the third-party custodian may prove its innocence by using a recorded signature flow (that is, self-verify legality and validity of the signature). The user terminal 20a may obtain, based on the object access data information (for example, face information of the user A), another local key (for example, the key fragment A1 shown in FIG. 2) stored by the resource management client, and perform service signing on the to-be-signed service Tx1 by using the key fragment A1, to obtain the service signature information 2 of the to-be-signed service Tx1. In this embodiment of the present disclosure, in the first threshold signature policy, service signature information (for example, the service signature information 1 shown in FIG. 2) that is obtained by signing by the key custody client in the business service device 20b by using the key fragment B1 is collectively referred to as service remote signature information. Similarly, in this embodiment of the present disclosure, another service signature information (for example, the service signature information 2 shown in FIG. 2) obtained by signing by the resource management client in the user terminal 20a by using the key fragment A1 may be collectively referred to as service local signature information. That is, in the first threshold signature policy, service signing performed by the resource management client by using the key fragment stored in the resource management client is referred to as service local signature information, and service signing performed by a remote key custody client other than the resource client by using the key fragment stored in the resource management client is referred to as service remote signature information.

The user terminal 20a aggregates and signs the service signature information 1 and the service signature information 2, and transmits obtained aggregated signature information C1 and the signed service Tx1 to a blockchain node in the blockchain shown in FIG. 2 by performing operation S17, so that when the blockchain node performs signature verification on the aggregated signature information C1 by using a global shared public key (which may also be referred to as a global aggregated public key), and when the signature verification succeeds, the blockchain node performs S18 of writing the signed service Tx1 into the blockchain shown in FIG. 1. The blockchain may be specifically a blockchain 11e maintained by a blockchain node deployed in the blockchain network 100d. The global shared public key (that is, the global aggregated public key) is obtained by performing aggregated calculation on a public key carried in the service remote signature information and a public key carried in the service local signature information.

In the embodiments of the present disclosure, a face (or another biological feature) recognition technology is involved. When the foregoing embodiments of the present disclosure are applied to a specific product or technology, a related data (for example, face information and a user password) collection, use, and processing process needs to comply with related legal and law requirements. In the embodiments of the present disclosure, before face information is collected, an information processing rule is notified and an independent agreement of a service object (for example, the user A shown in FIG. 2) is requested, the face information is processed strictly according to the legal and law requirements and a personal information processing rule, and a technical measure is configured for ensuring security of related data.

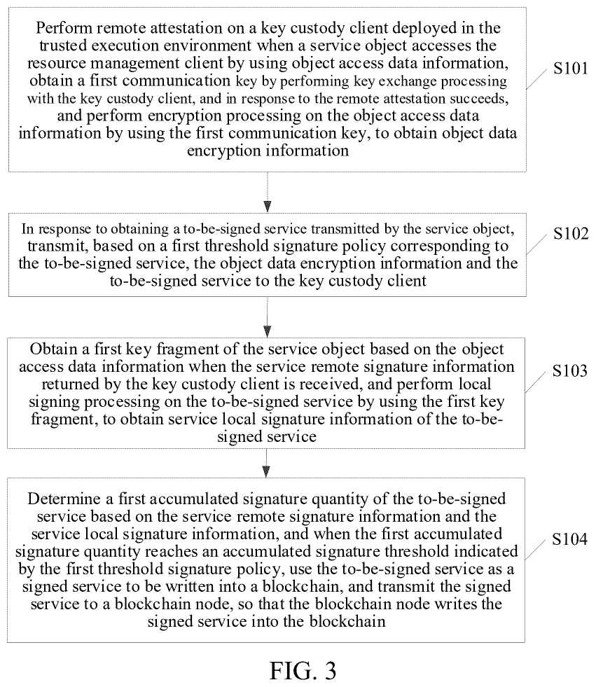

In the embodiments of the present disclosure, for a specific process in which the resource management client in the user terminal 20a performs remote attestation on the key custody client and the user terminal 20a obtains the signature information 1 and the signature information 2, refer to descriptions of embodiments corresponding to FIG. 3 to FIG. 12.

FIG. 3 shows a data processing method based on a trusted execution environment according to an embodiment of the present disclosure. The method may be performed by a resource management client. The resource management client herein may be integrated and run in a first service terminal. The first service terminal herein may be specifically the first service terminal 100b in the embodiment corresponding to FIG. 1. As shown in FIG. 3, the method may at least include operation S101 to operation S104.

Operation S101: Perform remote attestation on a key custody client deployed in the trusted execution environment when a service object accesses the resource management client by using object access data information, obtain a first communication key by performing key exchange processing with the key custody client, and in response to the remote attestation succeeds, perform encryption processing on the object access data information by using the first communication key, to obtain object data encryption information.

Because the resource management client is integrated and runs in the first service terminal, that the resource management client performs the following operation S101 to operation S104 may be equivalently described as that the first service terminal performs operation S101 to operation S104.

A specific process in which the first service terminal performs operation S101 may be as follows: The first service terminal may obtain the object access data information of the service object by using the resource management client, and when determining, based on the object access data information, that the service object has access permission for accessing the resource management client, allow, based on the access permission, the service object to access the resource management client, that is, the first service terminal may respond, based on the access permission, to a request of the service object for accessing the resource management client. The object access data information herein may include access password information entered by a service object (that is, a user such as the foregoing user A) when the service object accesses the resource management client. The first service terminal may perform, by using the resource management client, remote attestation on the key custody client deployed in the trusted execution environment, to obtain a remote attestation result. The first service terminal may determine that the remote attestation succeeds when the remote attestation result indicates that the trusted execution environment is a secure execution environment, and the key custody client is a trusted client in the secure execution environment. The first service terminal may obtain, when the remote attestation succeeds, the first communication key that is obtained by performing key exchange processing with the key custody client during the remote attestation. That is, the first communication key is obtained by performing key exchange processing between the resource management client and the key custody client when the resource management client performs remote attestation on the key custody client, and the remote attestation succeeds. Encryption processing is performed on the access password information in the object access data information by using the first communication key, to use the access password information obtained after the encryption processing as the object data encryption information of the service object.

The object access data information includes access password information (for example, a service character string such as a user password) entered by the service object when accessing the resource management client. In one or more implementations, the object access data information may further include other data information other than the access password information (for example, a service character string such as a user password), for example, access biological feature information (for example, biological feature information such as face information or fingerprint information). Specific data information included in the object access data information is not limited herein.

As can be seen, in this embodiment of the present disclosure, in a process of accessing the resource management client, the resource management client may be accessed by using a single-factor access policy (that is, any one of the foregoing service character string such as the user password and the face information). Certainly, to ensure security of access to the client, in this embodiment of the present disclosure, the resource management client may be cooperatively accessed by using a two-factor access policy (that is, the service character string such as the foregoing user password and the face information). For ease of understanding, in this embodiment of the present disclosure, an example in which an access policy configured for accessing the resource management client is a two-factor access policy is used. In this way, when a user logs in to the resource management client by entering a user password and swiping a face, remote attestation may be performed, by using the resource management client, on the key custody client deployed in the trusted execution environment.

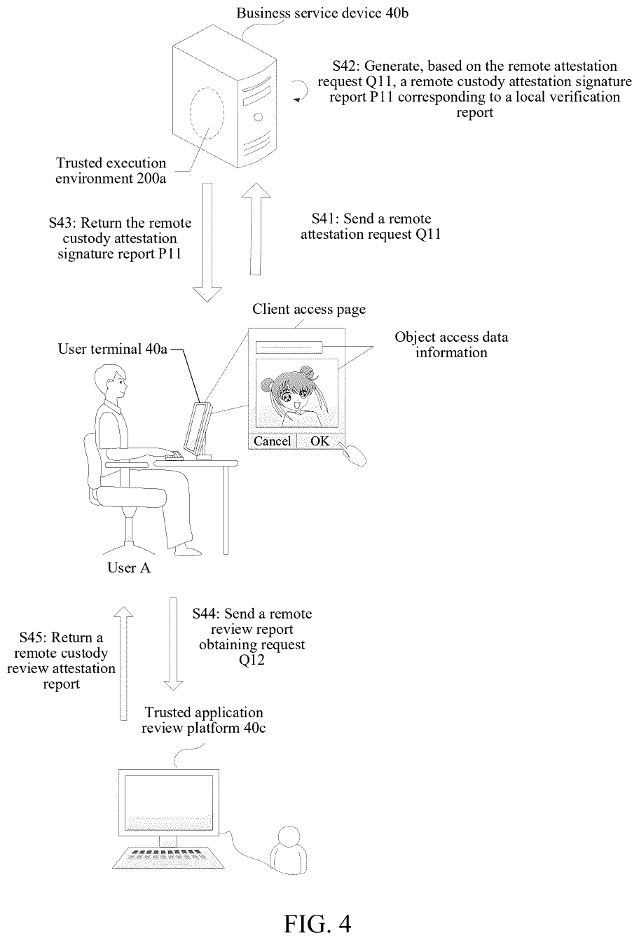

FIG. 4 is a schematic diagram of a remote attestation scenario according to an embodiment of the present disclosure. A user terminal 40a shown in FIG. 4 is a first service terminal, and a resource management client is integrated and runs in the user terminal 40a. A user A corresponding to the user terminal 40a is the service object, and a client access page shown in FIG. 4 is a visual access page provided by the resource management client. As shown in FIG. 4, the user A may enter a user password (for example, AABBCC) of the user A in a user password entry region based on access prompt information (for example, please enter a user password and face information) displayed on the client access page, and may invoke a camera of the user terminal 40a by triggering the face information collection region, to collect a face image of the user A, and display the collected face image of the user A in the face information collection region. In this embodiment of the present disclosure, the user password (for example, AABBCC) and the face image of the user A that are displayed on the client access page may be collectively referred to as object access data information entered by the user A. Schematically, in this embodiment of the present disclosure, when the resource management client responds to a trigger operation (for example, a confirmation operation) of the user A (that is, a service object) on the client access page, the user password (for example, AABBCC) entered by the user A and face information extracted from the face image of the user A are collectively referred to as object access data information.

When obtaining the object access data information entered by the service object (that is, the user A shown in FIG. 4), the user terminal 40a (that is, the first service terminal) may search a registration service database associated with the resource management client for object registration data information matching the object access data information, to obtain a data information search result.

In an implementation, a user password (for example, AABBCC) entered on the client access page may be collectively referred to as access password information, and face images configured for extracting face information of the user A entered on the client access page may be collectively referred to as access biological feature information. Specifically, the user terminal 40a (that is, the first service terminal) may search, when the obtained object access data information includes the access password information (for example, AABBCC) and the access biological feature information (for example, a face image including the face information of the user A collected during access), the registration service database associated with the resource management client for registration password information (for example, AABBCC) matching the access password information, and search the registration service database for registration biological feature information (for example, a face image including the face information of the user A collected during registration) matching the access biological feature information. If the data information search result indicates that the object registration data information matching the object access data information is found, the user terminal 40a (that is, the first service terminal) may determine that the service object is a registered object having access permission, and may further allow the service object to access the resource management client as the service object, that is, the user terminal 40a responds to the request of the service object for accessing the resource management client. In addition, the data information search result may include an information search success result or an information search failure result. In a case that the registration password information matching the access password information is found in the service database and the registration biological feature information matching the access biological feature information is found, it is determined that object registration data information matching the object access data information is found in the registration service database, and further an information search success result may be generated. In some embodiments, in this embodiment of the present disclosure, in a case that registration password information matching the access password information is not found in the service database, or registration biological feature information matching the access biological feature information is not found, it may be determined that object registration data information matching the object access data information is not found in the registration service database, and further, an information search failure result may be generated.

The user terminal 40a may determine, when the data information search result indicates that the object registration data information matching the object access data information is found, that the service object is a registered object having access permission, and allow the service object as the registered object to access the resource management client, perform operation S41 shown in FIG. 4, and transmit a remote attestation request Q11 shown in FIG. 4 to the business service device 40b on which a trusted execution environment 200a is deployed shown in FIG. 4. The business server 40b may perform operation S42 shown in FIG. 4, to generate, based on the remote attestation request Q11, a remote custody attestation signature report P11 corresponding to the local verification report, and may return the remote custody attestation signature report P11 to the user terminal 40a by performing operation S43.

The user terminal 40a (that is, the first service terminal) may perform operation S44, that is, transmit a remote review report obtaining request Q12 to a trusted application review platform 40c. The trusted application review platform involved in this embodiment of the present disclosure may perform, by using a plurality of review institutions in advance, multi-party review (that is, task review) on a key custody client uploaded by a development terminal. When the multi-party review succeeds, the key custody client uploaded by the development terminal is published to a service platform corresponding to the trusted application review platform. Meanwhile, in this embodiment of the present disclosure, a remote custody review attestation report for the published key custody client may further be generated after the multi-party review succeeds. In this way, the user terminal 40a (that is, the first service terminal) shown in FIG. 4 (that is, the first service terminal) may obtain, from the trusted application review platform 40c, the remote custody review attestation report obtained after a plurality of review institutions perform task review on the key custody client, and may perform parameter comparison on a key report parameter in the obtained remote custody review attestation report and a key report parameter in the remote custody attestation signature report. When the parameter comparison succeeds, it is determined that the key custody client is a trusted client in a secure execution environment, and a remote attestation result is generated. The remote attestation result is configured for indicating that the trusted execution environment is a secure execution environment. The key custody client is a trusted client in a secure execution environment.

The user terminal 40a (that is, the first service terminal) may obtain, when the remote attestation succeeds, the first communication key that is obtained by performing key exchange processing with the key custody client in the foregoing remote attestation process, and perform encryption processing on the object access data information (for example, the foregoing access password information) by using the first communication key, to use the access password information obtained after the encryption processing as the object data encryption information, so that operation S102 may be subsequently performed.

In some embodiments, for the foregoing single-factor access policy, if the object access data information entered by the user A on the client access page includes only the access biological feature information entered by the user A when accessing the resource management client, in this case, the user terminal 40a (that is, the first service terminal) may alternatively obtain, when the remote attestation succeeds, the first communication key obtained by performing key exchange processing with the key custody client in the foregoing remote attestation process, and perform encryption processing on the object access data information (for example, the foregoing access biological feature information) by using the first communication key, to use the access biological feature information obtained after the encryption processing as another type of object data encryption information, so that operation S102 may be performed subsequently.

In one embodiment, in this embodiment of the present disclosure, the service object may further be determined as a non-registered object when the foregoing data information search result indicates that no object registration data information matching the object access data information is found, further, access failure prompt information may be generated, and the access failure prompt information may be displayed on the client access page shown in FIG. 4 (for example, the user password is entered incorrectly or the face image is not matched).

In an implementation, a specific process in which the user terminal 40a (that is, the first service terminal) performs, by using the resource management client, remote attestation on the key custody client deployed in the trusted execution environment, to obtain a remote attestation result may be described as follows: The first service terminal may be configured to: generate a first random number configured for performing remote attestation, and generate a first communication key pair configured for data communication, use the first random number and a first communication public key in the first communication key pair as request parameters, generate a first remote attestation request based on the request parameters, and transmit the first remote attestation request to the key custody client. The key custody client may generate a second communication key pair based on the first remote attestation request, and use a second communication public key in the second communication key pair and the first random number in the received remote attestation request as report parameters to generate a local verification report carrying the report parameters. The local verification report is configured for indicating a local platform attestation signature component associated with the trusted execution environment to perform local verification on the local verification report, and generate a remote custody attestation signature report corresponding to the local verification report when the local verification succeeds. The first service terminal may receive the remote custody attestation signature report returned by the local platform attestation signature component, obtain an custody environment attestation report provided by a remote attestation server, and determine that the trusted execution environment is a secure execution environment when it is determined, based on the custody environment attestation report, that the remote custody attestation signature report is a valid attestation report; and obtain, from a trusted client review platform associated with the resource management client, a remote custody review attestation report obtained after a plurality of review institutions perform task review on the key custody client. The first service terminal may perform parameter comparison between a key report parameter in the remote custody review attestation report and a key report parameter in the remote custody attestation signature report, and determine that the key custody client is a trusted client in the secure execution environment when the parameter comparison succeeds, and generate the remote attestation result, the remote attestation result being configured for indicating that the trusted execution environment is a secure execution environment, and the key custody client being a trusted client in the secure execution environment.

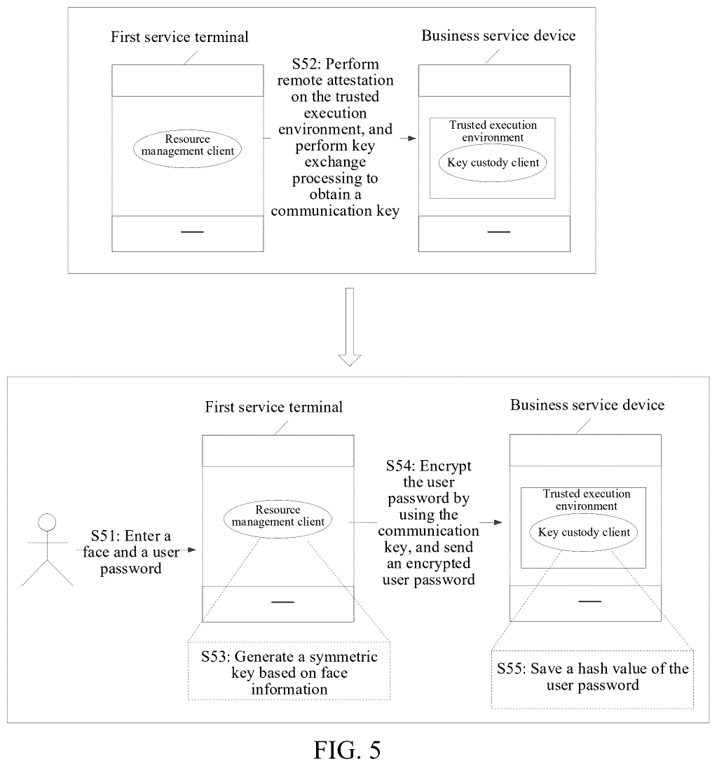

The first remote attestation request involved in this embodiment of the present disclosure is a remote attestation request initiated when the user terminal 40a (that is, the first service terminal) successfully accesses the resource management client. For ease of understanding, in this embodiment of the present disclosure, another remote attestation request initiated by the user terminal 40a (that is, the first service terminal) when registering with the resource management client may be collectively referred to as a second remote attestation request. In this embodiment of the present disclosure, a process in which the service object (for example, the user A) accesses the resource management client is referred to as a user access stage, and a process in which the service object registers with the resource management client in the user terminal 40a is referred to as a user registration stage. FIG. 5 is a schematic diagram of a scenario of a user registration procedure according to an embodiment of the present disclosure. As shown in FIG. 5, when a service object (for example, a user A) downloads and installs a resource management client from an application market by using a first service terminal, and a business service device may run a key custody client uploaded by a development terminal, in this case, the user A may register the resource management client, and perform operation S51 shown in FIG. 5, to enter a face and a user password on a client registration page displayed on the first service terminal. This means that the first service terminal may obtain, by using the resource management client, a face image including a face and a user password entered by the user A, and the obtained face image including a face and user password may be collectively referred to as the foregoing registration object data information.

The face image including a face in the registration object data information may be referred to as registration biological feature information of the user A, and the user password in the registration object information may be referred to as access password information entered by the user A. When obtaining the registration object data information entered by the user A, the resource management client may store the registration object data information into a registration service database associated with the resource management client. In this way, when subsequently accessing the resource management client by using the face and the user password, the user A may compare the face and the user password that are currently entered by the user A in an access stage with the face and the user password that are historically stored in the registration service database and that are entered by the user A in a registration stage, and when the comparison is consistent, the resource management client determines that the user A is a registered object having access permission to access the resource management client, thereby allowing the user A to access the resource management client.

The registration service database may be a database that exists in the first service terminal and that is configured for locally storing registration object data information. In one or more implementations, the registration service database may alternatively be another database that exists in another device (for example, a background service device of the resource management client) independent of the first service terminal and that is configured to store the registration object data information in an encrypted manner. For example, to ensure security of the registered object data information that is stored in an encrypted manner, in this embodiment of the present disclosure, a hash value of the registered object data information calculated according to the face image including the face and the user password may further be stored in the background service device. In this way, when the user A accesses the resource management client by using the face image protecting the face and the user password, a hash value that is of access object data information and that is obtained by latest calculation according to the currently obtained face image including the face and the user password may be compared with a hash value that is of registration object data information and that is remembered by historical calculation. When the hash values are consistent, access to the resource client is rapidly implemented.

Further, the first service terminal may perform operation S52, to perform, by using the resource management client shown in FIG. 5, remote attestation on the trusted execution environment deployed in the business service device shown in FIG. 5, and when the remote attestation succeeds, obtain a current communication key (that is, a second communication key) obtained by performing key exchange processing between the resource management client and the key custody client in a process of the remote attestation.

In this embodiment of the present disclosure, a communication key obtained by the user A by performing key exchange processing between the resource management client and the key custody client in a user registration stage may be referred to as a second communication key, and a new communication key obtained by the user A by performing key exchange processing between the resource management client and the key custody client in a user access stage may be referred to as a first communication key. In other words, in this embodiment of the present disclosure, in a process in which the resource management client and the key custody client perform data exchange, the communication key obtained through real-time key exchange processing may be configured for ensuring security and reliability of data transmission in the data exchange process, thereby improving, in the business service device, access security of authorizing the user A (that is, the service object) to access the custodial key fragment by using the key custody client. In this embodiment of the present disclosure, even if a third-party custodian corresponding to the key custody client does not have access permission to access the custodial key fragment directly by using the key custody client, reliability and security of the custodial key fragment stored in the trusted execution environment can be ensured.

In this embodiment of the present disclosure, each time the user A accesses the resource management client, remote attestation on the resource management client may be triggered, to ensure environment security of the trusted execution environment running in the business service device and application security of the key custody client running in the trusted execution environment.

As shown in FIG. 5, the first service terminal may extract, in the user registration stage, face information from the obtained face image including a face, and perform operation S53 shown in FIG. 5. That is, in this case, the first service terminal may generate, based on the extracted face information of the user A, a symmetric key (that is, a registration symmetric key) in the user registration stage, and perform encryption processing, by using the symmetric key (that is, the registration symmetric key), on the local key fragment (that is, the first key fragment, where the first key fragment may be specifically the foregoing online key fragment) generated by the resource management client; and store, into a resource management memory of the resource management client, a first encryption key fragment obtained after encryption processing and the foregoing registration symmetric key together. In this way, when subsequently performing multi-party threshold signature on the first service terminal and the business service device, a new symmetric key (that is, an access symmetric key) may be generated by using latest face information obtained when the resource management client is currently accessed, and further, when the registration symmetric key keeps consistent (or matches) with an access symmetric key, the first key fragment may be obtained through decryption by using the access symmetric key, so that a multi-party threshold signature operation in the following operation S103 is performed by using the first key fragment.

Because the service signature policy involved in this embodiment of the present disclosure is a threshold signature policy, as shown in FIG. 5, the first service terminal may further perform operation S54 in the user registration stage, that is, encrypt, by using the communication key (that is, the second communication key), the user password that is entered by the user A in the user registration stage, and transmit the encrypted user password to a business server. In this case, the business service device may decrypt the communication key (that is, the second communication key) to obtain the user password transmitted by the resource management client, and when performing operation S55, store a calculated hash value of the user password into the trusted enclave custody of the key custody client. In this way, subsequently, in the user access stage, when decrypting a new communication key (that is, the first communication key) to obtain a user password, the business service device may compare a hash value of the user password that is currently recalculated in the user access stage with a hash value of the user password that is historically calculated in the user registration stage. If the hash values are consistent, it may be determined that remote identity authentication (that is, remote information authentication) on the user A (that is, the service object) is completed, and further, the user A may be authorized to invoke the key custody fragment to perform service signing when the remote identity authentication (that is, remote information authentication) succeeds.

In one or more implementations, in this embodiment of the present disclosure, the user password may alternatively be directly kept in the trusted enclave custody of the key custody client located in the trusted execution environment. In this way, the registration password information (for example, the user password) stored in the trusted enclave custody of the key custody client may be configured for performing remote information authentication on the access password information in the obtained object access data information, and authorizing the service object to invoke the custodial key fragment when the remote information authentication succeeds.

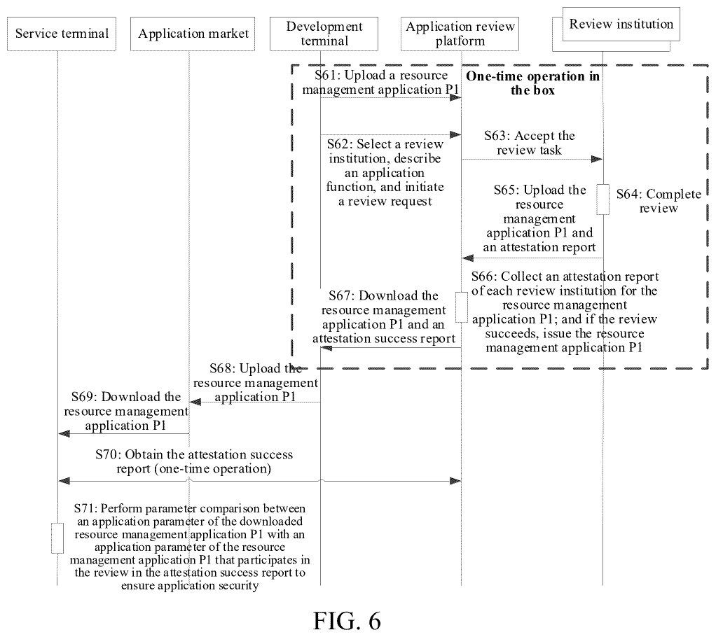

For a specific process in which the service object (for example, the user A) in the foregoing embodiment corresponding to FIG. 5 downloads and installs the resource management client from the application market by using the first service terminal, refer to FIG. 6 together, which is an interaction sequence diagram of developing, reviewing, and installing a resource management client according to an embodiment of the present disclosure. A resource management application P1 shown in FIG. 6 may be a resource management client integrated and running in the first service terminal shown in FIG. 5. In addition, the service terminal shown in FIG. 6 may be specifically the first service terminal shown in FIG. 5.

When completing program development on the resource management application P1 (that is, the resource management client) by using a development terminal shown in FIG. 6, a developer (for example, a developer K1) may perform operation S61 shown in FIG. 6, to upload the resource management application P1 (that is, the resource management client) to an application review platform shown in FIG. 6, and may synchronously perform operation S62 when uploading the resource management application P1, to select a plurality of review institutions (for example, a review institution H1, a review institution H2, and a review institution H3) for performing application review on an application function of the resource management application P1. The development terminal may initiate a review request to the application review platform shown in FIG. 6 based on the selected review institution and the described application function of the resource management application P1.

When obtaining the review request, the application review platform may perform operation S63, that is, extract a review task from the review request and receive the review task. This means that in this case, the application review platform may deliver, based on the review task, a review instruction for performing application review on the application function of the resource management application P1 to a plurality of selected review institutions (for example, the review institution H1, the review institution H2, and the review institution H3). In this way, for each of the plurality of review institutions, operation S64 may be performed when the review instruction is received, to perform application review on the application function of the resource management application P1, and operation S65 shown in FIG. 6 may be performed when the review is completed, to upload the resource management application P1 that currently completes review and a review attestation report (which is briefly referred to as an attestation report) to the application review platform.

When performing operation S66, the application review platform may collect review attestation reports (attestation reports for short) returned by a plurality of selected review institutions for the resource management application P1, and may obtain, from each collected attestation report, whether an accumulated review score of a key review dimension (for example, whether application data is complete and whether an application function meets a review indicator) reaches a review threshold. When an accumulated review score of a key review dimension in each attestation report reaches the review threshold, it is determined that the review succeeds, and the resource management application P1 that succeeds in review may be published on the review platform.

The application review platform may notify the development terminal to perform operation S67, that is, may notify the development terminal to download the reviewed resource management application P1 and the report indicating that the reviewed resource management application P1 succeeds in attestation. The development terminal may perform operation S68 shown in FIG. 6, and upload the resource management application P1 that currently succeeds in review to an application market. Subsequently, when a service object (for example, the foregoing user A) needs to use the resource management application P1, the development terminal may perform operation S69, and download the resource management application P1 from the application market.

To ensure application security of the resource management application P1 currently downloaded to the service terminal, as shown in FIG. 6, before integrating and installing the resource management application P1 in the service terminal (that is, the first service terminal), the service terminal may perform operation S70, that is, obtain, from the application review platform, an attestation success report issued for the resource management application P1. The service terminal may further perform operation S71, that is, use the resource management application P1 downloaded from the application market as a to-be-compared resource management application (for example, a resource management application P1′). In this case, the service terminal may determine whether application parameters (for example, an ND5 file configured for describing an application name of the resource management application P1′, an application version of the resource management application P1′, and developer information) of the to-be-compared resource management application (for example, the resource management application P1′) are consistent with application parameters, recorded in an obtained attestation success report, of the resource management application P1 that actually participates in the review. If the application parameters are consistent, it may be determined that the resource management application P1 currently downloaded to the service terminal (that is, the first service terminal) has application security, so that an application program of the resource management application P1 may be allowed to be integrated and installed on the service terminal, so that the foregoing operations of operation S101 to operation S104 may continue to be performed. On the contrary, when the application parameters of the currently downloaded resource management application P1 (that is, the to-be-compared resource management application (for example, the resource management application P1′)) are inconsistent with the application parameters of the resource management application P1 actually participating in the review, it is determined that the resource management application P1 currently downloaded to the service terminal (that is, the first service terminal) does not have application security, and then risk prompt information configured for prompting a user that the currently downloaded resource management application P1 has an installation risk may be generated.

The attestation success report is a review attestation success report obtained according to a one-time operation corresponding to operation S61 to operation S67. That is, in this embodiment of the present disclosure, a one-time application review operation may be performed on the currently developed resource management application P1, and when the review succeeds, the development terminal is allowed to download the resource management application P1 and the attestation success report thereof from the application review platform.

The third-party custodian (for example, a custodial user B) in the embodiment corresponding to FIG. 5 may receive, by using the business server, the trusted application uploaded by the development terminal, and run, in the business server, an application function service provided by the trusted application. The trusted application herein may specifically include, but is not limited to, the key custody client and the log recording client in the embodiment corresponding to FIG. 2.

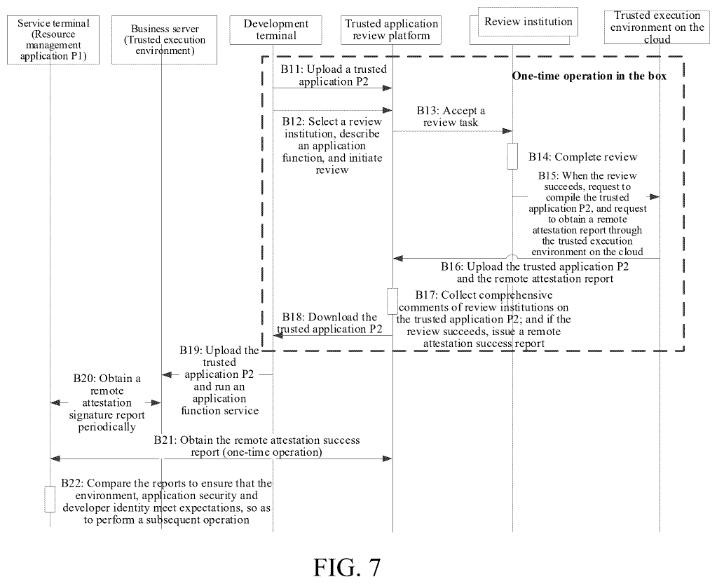

FIG. 7 is an interaction sequence diagram of developing, reviewing, installing, and performing remote application attestation on a trusted application according to an embodiment of the present disclosure. For ease of understanding, an embodiment of the present disclosure uses an example in which a trusted application P1 shown in FIG. 7 may be the key custody client integrated and running in the business service device shown in FIG. 5, to describe a specific procedure of developing, reviewing, installing, and remote application attestation on the key custody client.

When a developer (for example, a developer K2) completes program development on a trusted application P2 (for example, the key custody client) by using a development terminal shown in FIG. 7, operation B11 shown in FIG. 7 may be performed, and the trusted application P2 (for example, the key custody client) is uploaded to a trusted application review platform shown in FIG. 7.

For ease of distinction, in this embodiment of the present disclosure, applications that need to be deployed and run in a trusted execution environment are collectively referred to as a trusted application, and review platforms configured for performing application review on the trusted applications are collectively referred to as a trusted application review platform (for example, a review platform configured for performing application review on the trusted application P2 (for example, the key custody client) shown in FIG. 7). Similarly, in this embodiment of the present disclosure, applications that do not need to be deployed and run in a trusted execution environment may be collectively referred to as an ordinary application, and review platforms configured for performing application review on the ordinary applications may be collectively referred to as an application review platform (for example, the review platform configured for performing application review on the resource management client P1 shown in FIG. 6).

As shown in FIG. 7, when uploading the trusted application P2 (for example, the key custody client), the development terminal performs operation B12, that is, selects a plurality of review institutions (for example, a review institution H3, a review institution H4, and a review institution H5) that perform application review on an application function of the trusted application P2 (for example, the key custody client). In this case, the development terminal may initiate a trusted review request to the trusted application review platform shown in FIG. 7 based on the selected review institutions and the described application function of the trusted application P2 (for example, the key custody client).

When obtaining the trusted review request, the trusted application review platform may perform operation B13, that is, extract a review task from the trusted review request and receive the review task. This means that the trusted application review platform may deliver, based on the review task, a review instruction of performing application review on the application function of the trusted application P2 (for example, the key custody client) to a plurality of selected review institutions (for example, the review institution H3, the review institution H4, and the review institution H5). In this way, for each of the plurality of review institutions, operation B14 may be performed when the review instruction is received, to perform application review on the application function of the trusted application P2 (for example, the key custody client), and operation B15 shown in FIG. 7 may be performed when the review is completed, so as to transmit the trusted application P2 (for example, the key custody client) that currently completes review to a target service node on which a trusted execution environment in the cloud (or a public trusted execution environment in the cloud) is deployed, so that the target service node may compile the trusted application P2 (for example, the key custody client) in the trusted execution environment in the cloud, and may receive, when the trusted application P2 (for example, the key custody client) is successfully compiled in the trusted execution environment in the cloud, remote attestation initiated by the review institution in the application review stage on the trusted application P2 (for example, the key custody client) running in the trusted execution environment in the cloud.

This means that each review institution obtains, in the application review stage, a remote attestation report indicating that the review institution performs remote attestation on the trusted application P2 (for example, the key custody client). The remote attestation report herein is a remote attestation signature report corresponding to a local verification report obtained after a remote attestation signature component that is in the same trusted execution environment as the trusted application P2 performs local verification on a local verification report generated by the trusted application P2. In this way, when each review institution obtains a trusted environment attestation report in the cloud that is provided by the remote attestation server for the trusted execution environment in the cloud, the remote attestation signature report may be determined as a valid attestation report based on the trusted environment attestation report in the cloud, and further, the trusted application P2 compiled in the trusted execution environment in the cloud may be determined as a trusted application by using the remote attestation signature report (that is, the remote attestation report shown in FIG. 7) as a valid report.

When the trusted application P2 is the foregoing key custody client, the remote attestation signature report may be specifically a remote custody attestation signature report. In some embodiments, when the trusted application P2 is the foregoing log recording client, the remote attestation signature report may further be specifically a remote log attestation signature report.

As shown in FIG. 7, the trusted application review platform may further perform operation B16 to obtain, from the trusted execution environment in which the trusted application P2 is compiled, the currently compiled trusted application P2 and a remote attestation report associated with each review institution. In this way, when performing operation B17, the trusted application review platform may collect remote attestation reports returned by a plurality of selected review institutions for the trusted application P1, obtain whether an accumulated review score of a key review dimension (for example, whether data of the trusted application is complete, and whether a function of the trusted application meets a review indicator) reaches a review threshold from the collected remote attestation reports, and determine that the review succeeds when the accumulated review score of the key review dimension in each remote attestation report reaches the review threshold, and publish a remote attestation success report of the trusted application P2 that succeeds in the review on the trusted review platform.

The trusted application review platform may notify the development terminal to perform operation B18, that is, may notify the development terminal to download the trusted application P2 that succeeds in review. The development terminal may perform operation B19 shown in FIG. 7, and upload the trusted application P2 that currently succeeds in review to the business server on which the trusted execution environment is deployed, so that the application function service of the trusted application P2 may be integrated and run in the business server on which the trusted execution environment is deployed. In this way, subsequently, when a service object (for example, the foregoing user A) needs to perform multi-party threshold signature by using a service terminal integrated with the resource management application P1, operation B20 shown in FIG. 7 may be performed, so as to perform, by using the resource management application P1, remote attestation on the trusted application P2 running in the trusted execution environment of the business server, to obtain a remote attestation signature report returned by the business server.

To ensure application security and environment security of the trusted application P2 currently running on the business server, the service terminal may obtain, from the trusted application review platform by using the resource management application P1 to perform operation B21, to obtain a remote attestation success report issued for the trusted application P2 from the trusted application review platform. For example, when the trusted application P2 is a key custody client, the service terminal may obtain, from the trusted application review platform by using the resource management client P1, a remote custody review attestation report obtained after a plurality of review institutions perform task review for the key custody client. The service terminal may perform operation B22, to perform parameter comparison between a key report parameter of the remote attestation success report (for example, the remote custody review attestation report obtained by reviewing the key custody client) and a key report parameter in the remote custody attestation signature report obtained by currently performing remote attestation, and when the parameter comparison succeeds, the key custody client deployed in the trusted execution environment is determined as a trusted client.

Operation S102: Transmit, in response to obtaining a to-be-signed service transmitted by the service object, the object data encryption information and the to-be-signed service to the key custody client based on a first threshold signature policy corresponding to the to-be-signed service, so that the key custody client obtains the object access data information through decryption based on the first communication key, performs identity verification on the service object by using the object access data information, and when the identity verification succeeds, performs remote signing processing on the to-be-signed service by using a custodial key fragment stored in the key custody client, to obtain service remote signature information of the to-be-signed service.

Operation S103: Obtain a first key fragment of the service object based on the object access data information when the service remote signature information returned by the key custody client is received, and perform local signing processing on the to-be-signed service by using the first key fragment, to obtain service local signature information of the to-be-signed service.

A resource management memory of the resource management client stores a registration symmetric key and a first encryption key fragment corresponding to the first key fragment; the registration symmetric key is generated from registration biological feature information provided by the service object when registering with the resource management client; the first encryption key fragment is obtained after encryption processing is performed on the first key fragment by using the registration symmetric key when the service object is a registered object; and a specific process in which the first service terminal performs operation S103 by using the resource management client may be described as follows: The first service terminal may obtain, from the object access data information according to an online fragment encryption policy in an object registration policy when the service remote signature information returned by the key custody client is received, access biological feature information provided by the service object when accessing the resource management client; the first service terminal may generate an access symmetric key by using the access biological feature information, and obtain the registration symmetric key and the first encryption key fragment from the resource management memory; the first service terminal may perform decryption processing on the first encryption key fragment by using the access registration key matching the registration symmetric key when it is determined that the registration symmetric key matches the access symmetric key, to restore and obtain the first key fragment corresponding to the first encryption key fragment; and the first service terminal may perform local signing processing on the to-be-signed service by using the first key fragment, to obtain the service local signature information of the to-be-signed service.

For a specific process in which the first user terminal performs signing processing on the to-be-signed service by using the first key fragment, to obtain the service local signature information refer to the foregoing description of the specific process of obtaining the signature information 2 in the embodiment corresponding to FIG. 2, and details are not described herein again.

Operation S104: Determine a first accumulated signature quantity of the to-be-signed service based on the service remote signature information and the service local signature information, and when the first accumulated signature quantity reaches an accumulated signature threshold indicated by the first threshold signature policy, use the to-be-signed service as a signed service to be written into a blockchain, and transmit the signed service to a blockchain node, wherein the signed service is written into the blockchain by the blockchain node into the blockchain.

Specifically, the first service terminal may accumulate the first signature quantity of the service remote signature information and the service local signature information based on the first threshold signature policy, and use the accumulated first signature quantity as the first accumulated signature quantity of the to-be-signed service. The first service terminal performs aggregated signing on the service remote signature information and the service local signature information based on the first threshold signature policy when the first accumulated signature quantity reaches the accumulated signature threshold indicated by the first threshold signature policy, to obtain first aggregated signature information of the to-be-signed service, and uses, based on the first aggregated signature information, the to-be-signed service as a signed service to be written into the blockchain. The first service terminal may transmit the signed service and the first aggregated signature information to the blockchain node, so that the blockchain node performs aggregated signature verification on the signed service based on the global aggregated public key carried in the first aggregated signature information, and writes, when the aggregated signature verification succeeds, the signed service into a blockchain maintained by the blockchain node; and the global aggregated public key is obtained by performing aggregated calculation on a public key carried in the remote signature information and a public key carried in the local signature information.

As can be seen, in this embodiment of the present disclosure, the key fragments are deployed on different client terminals (for example, the first key fragment may be encrypted and stored on the resource management client, and the custodial key fragment may be stored on the key custody client deployed in the trusted execution environment), so as to ensure security of key storage, thereby improving reliability of service signing during a service signing process. For example, in this embodiment of the present disclosure, the key custody client is deployed in a trusted execution environment, to resolve, from a root point, a problem of illegal leakage of a custodial key fragment caused by device loss of a key custody device possessed by a third-party custodian. The custodial key fragment is encrypted and stored, and may also prevent illegal leakage of a first key fragment caused by loss of a service terminal possessed by a user. In addition, in this embodiment of the present disclosure, a first accumulated signature quantity of the to-be-signed service may be determined based on the service remote signature information and the service local signature information, and when the first accumulated signature quantity reaches an accumulated signature threshold indicated by the first threshold signature policy, the to-be-signed service is used as a signed service to be written into a blockchain, and the signed service is transmitted to a blockchain node, wherein the signed service is written into the blockchain by the blockchain node into the blockchain. In other words, in this embodiment of the present disclosure, by using a threshold signature policy (herein, a policy in which a user and a third-party custodian may jointly participate in performing cooperative signing), a current service (that is, a to-be-signed service) may be determined as a signed service depending on a plurality of pieces of signature information that reaches an accumulated signature threshold (for example, two pieces), and further the signed service may be written into the blockchain by using a blockchain node, to ensure reliability of service on-chaining.

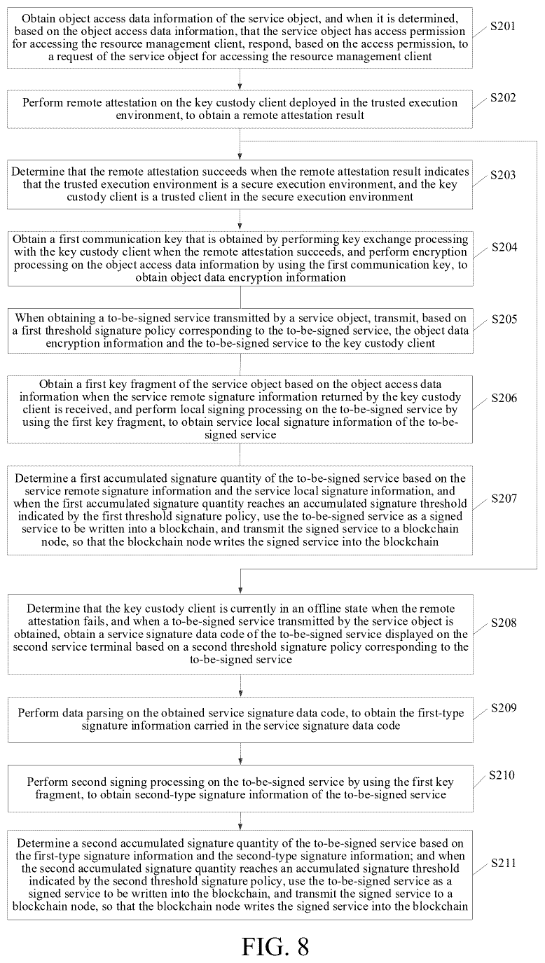

FIG. 8 is a schematic flowchart of a data processing method based on a trusted execution environment according to the present disclosure. As shown in FIG. 8, the method may be performed by a resource management client. The resource management client herein may be integrated and run in a first service terminal. The first service terminal herein may be specifically the first service terminal 100b in the embodiment corresponding to the foregoing FIG. 1. As shown in FIG. 8, the method may at least include operation S201 to operation S211.

Operation S201: Obtain object access data information of the service object, and when it is determined, based on the object access data information, that the service object has access permission for accessing the resource management client, respond, based on the access permission, to a request of the service object for accessing the resource management client. The object access data information includes access password information entered by the service object when accessing the resource management client.

Operation S202: Perform remote attestation on the key custody client deployed in the trusted execution environment, to obtain a remote attestation result.

Specifically, the first service terminal may generate, by using the resource management client, a first random number configured for performing remote attestation, use the first random number and a first communication public key in the first communication key pair as request parameters when generating a first communication key pair configured for data communication, and generate a first remote attestation request based on the request parameters. The first service terminal may transmit the first remote attestation request to the key custody client, so that the key custody client generates a second communication key pair based on the first remote attestation request, and uses a second communication public key in the second communication key pair and the first random number in the received remote attestation request as report parameters to generate a local verification report carrying the report parameters; and the local verification report is configured for indicating a local platform attestation signature component associated with the trusted execution environment to perform local verification on the local verification report, and generate a remote custody attestation signature report corresponding to the local verification report when the local verification succeeds. Further, the first service terminal may receive the remote custody attestation signature report returned by the local platform attestation signature component, obtain an custody environment attestation report provided by a remote attestation server, determine that the trusted execution environment is a secure execution environment when it is determined, based on the custody environment attestation report, that the remote custody attestation signature report is a valid attestation report, and obtain, from a trusted client review platform associated with the resource management client, a remote custody review attestation report obtained after a plurality of review institutions perform task review on the key custody client. The first service terminal may perform parameter comparison between a key report parameter in the remote custody review attestation report and a key report parameter in the remote custody attestation signature report, and determine that the key custody client is a trusted client in the secure execution environment when the parameter comparison succeeds, and generate the remote attestation result, the remote attestation result being configured for indicating that the trusted execution environment is a secure execution environment, and the key custody client being a trusted client in the secure execution environment.

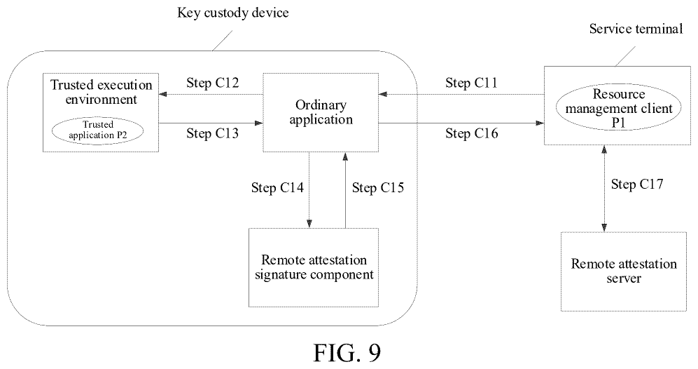

For ease of understanding, further, refer to FIG. 9, which is an interaction flowchart of performing remote attestation according to an embodiment of the present disclosure. A service terminal shown in FIG. 9 may be the foregoing first service terminal. A resource management client P1 is integrated and runs in the service terminal shown in FIG. 9. Similarly, a key custody device shown in FIG. 9 may be the foregoing business service device on which a trusted execution environment is deployed, and a trusted application P2 running on the key custody device may be specifically the foregoing key custody client.

Specifically, before the resource management client P1 performs multi-party threshold signature by using the trusted application P2 (for example, a key custody client), the service terminal may perform operation C11 shown in FIG. 9. In this case, the service terminal shown in FIG. 9 may generate, by using the resource management client, a random number (that is, the foregoing first random number), simultaneously generate a communication key pair A1 (that is, the foregoing first communication key pair) configured for performing data communication, and use a public key (that is, a first communication public key) of the communication key pair A1 (that is, the foregoing first communication key pair) and the random number (that is, the foregoing first random number) as request parameters, so that by using an ordinary application shown in FIG. 9, a remote attestation request (that is, the foregoing first remote attestation request) is initiated to the trusted application P2 (for example, the key custody client) deployed on the key custody device shown in FIG. 9.

The ordinary application shown in FIG. 9 may perform operation C12, to transmit the request parameters in the received remote attestation request to the trusted application P2 (for example, the key custody client) deployed in the trusted execution environment. In this case, the trusted application P2 (for example, the key custody client) deployed in the trusted execution environment may generate, based on the received request parameters (that is, the first communication public key and the first random number), another communication key pair (for example, a communication key pair B1) configured for performing data communication, so that a public key (that is, a second communication public key) of the communication key pair B1 and the received random number (that is, the first random parameter) may be used as report parameters. Further, the trusted application P2 (for example, the key custody client) may invoke an EREPORT instruction of SGX to create a REPORT (that is, a local verification report carrying the report parameters) that can be locally verified (without invoking an IAS) of a current platform QE (that is, a remote attestation signature component that is located on the same platform as the trusted execution environment and that is shown in FIG. 9).

The trusted application P2 (for example, the key custody client) may transmit the REPORT (that is, the local verification report carrying the report parameters) to the QE (that is, the remote attestation signature component that is located on the same platform as the trusted execution environment and that is shown in FIG. 9) by using the ordinary application when performing operation C13. Specifically, as shown in FIG. 9, the ordinary application may receive the REPORT (that is, the local verification report carrying the report parameters) transmitted by the trusted application P2 (for example, the key custody client) when performing operation C13, and forward the REPORT (that is, the local verification report carrying the report parameters) to the QE (that is, the remote attestation signature component that is located on the same platform as the trusted execution environment and that is shown in FIG. 9) by using operation C14.

The QE (that is, the remote attestation signature component shown in FIG. 9) may invoke EGETKEY to obtain a REPORT KEY (that is, a key report parameter in the local verification report), and may implement local verification on the REPORT by using the obtained key report parameter, so as to determine, according to a local verification result, whether the trusted execution environment in which the trusted application P2 is located and the QE run on the same platform. If the local verification result indicates that local verification succeeds, the QE (that is, the remote attestation signature component shown in FIG. 9) may sign the REPORT by using a platform private key signature unique to this platform, to obtain Quote (that is, the remote attestation signature report corresponding to the local verification report may be obtained, which may be specifically, for example, a remote custody attestation signature report).

The QE (that is, the remote attestation signature component shown in FIG. 9) may forward the Quote (that is, the remote attestation signature report corresponding to the local verification report may be obtained, which may be, for example, specifically a remote custody attestation signature report) to the ordinary application shown in FIG. 9 by using operation C15. Further, when performing operation C16, the ordinary application may return the received Quote (that is, the remote attestation signature report corresponding to the local verification report may be obtained, which may be, for example, specifically a remote custody attestation signature report) to the service terminal shown in FIG. 9. In this case, the service terminal may invoke the remote attestation server shown in FIG. 9 by using the resource management client P1, to verify, by using an environment attestation report (for example, the foregoing custody environment attestation report) provided by the remote attestation server, whether the remote custody attestation signature report is a valid attestation report.

A remote attestation server involved in this embodiment of the present disclosure may be specifically an Intel attestation server (IAS) configured to verify validity of the remote attestation signature report. In other words, in this embodiment of the present disclosure, the remote attestation server may help the service terminal to further determine that the trusted execution environment deployed in the key custody device is a secure execution environment in a case of determining that the remote attestation signature report is a valid attestation report, so that a remote review attestation report (which, for example, may be specifically a remote custody review attestation report) obtained from the trusted application review platform may be subsequently compared with a remote attestation signature report that is currently considered as a valid attestation report, and then the key custody client deployed in the secure execution environment may be determined as a trusted client in a case that the comparison succeeds.

In the foregoing schematic interaction flowchart provided in FIG. 9, the resource management client P1 in the service terminal and the trusted application P2 (for example, the key custody client) deployed in the trusted execution environment may both calculate the same and symmetric communication key (for example, the foregoing first communication key) with reference to a private key thereof and a public key of the other party, so that a subsequent communication encryption process may be performed by using the communication keys calculated in real time in the attestation process.

In this embodiment of the present disclosure, in a key exchange processing process of the communication key (that is, the first communication key), it may be ensured that an environment (for example, the foregoing trusted execution environment in the cloud) participating in attestation is the same as an environment in which the application actually runs. Because another environment does not participate in the key exchange processing, the communication key cannot be calculated, and naturally, communication content transmitted when the service terminal and the key custody device perform data communication cannot be decrypted. In addition, because Quote (that is, the remote attestation signature report corresponding to the local verification report may be obtained) includes a real-time generated random number (that is, the foregoing first random number), it can be ensured that the trusted application P2 cannot use an expired local attestation report to bypass the remote attestation, thereby ensuring real-time performance of the remote attestation to some extent, and ensuring environment security of a running environment in which the trusted application P2 is currently located.

The service terminal performs parameter comparison related to the resource management client P1, specifically, may verify whether an application program signer in the remote attestation signature report is consistent with an application program signer in the remote review attestation report that participates in the review. If the application program signer is consistent with the application program signer in the remote review attestation report that participates in the review, it may be ensured that the trusted application P2 is developed by an expected developer, so as to prevent an unexpected third party from fraudulently obtaining information stored in the trusted application P2 in a case that the unexpected third party illegally obtains the key custody device. In addition, the parameter comparison involved in this embodiment of the present disclosure may alternatively be specifically verifying whether an application program metric value for the trusted application P2 in the remote attestation signature report is consistent with that of an application program signer of the trusted application P2 in a remote review attestation report that participates in the review, and if they are consistent, it is determined that the trusted application P2 deployed in a trusted execution environment is a trusted application. During remote attestation, an application metric value of the trusted application P2 is calculated in real time by an Intel SGX CPU according to an application program, running in a trusted execution environment, of the trusted application P2, cannot be tampered with, and is a unique mark of the application program. Therefore, before invoking the trusted application P2 by using the resource management client, the service terminal may determine whether the value satisfies an expectation, and may further invoke the trusted application P2 in a case that the value satisfies the expectation, thereby effectively preventing a tampered application from being invoked.

Operation S203: Determine that the remote attestation succeeds when the remote attestation result indicates that the trusted execution environment is a secure execution environment, and the key custody client is a trusted client in the secure execution environment.

To ensure security and reliability of the key custody client stored in the trusted execution environment, before the resource management client and the key custody client perform multi-party threshold signature, environment security of the trusted execution environment in which the key custody client is stored needs to be verified by using a threshold signature policy, and further, in a case that it is ensured that the trusted execution environment is a secure execution environment, whether the key custody client deployed in the trusted execution environment is a trusted client may be verified, so that it may be determined that the remote attestation succeeds when the trusted execution environment is a secure execution environment and the key custody client is a trusted client. Therefore, multi-party threshold signature may be implemented by using the first threshold signature policy in the threshold signature policy. That is, in this embodiment of the present disclosure, the following operation S204 and operation S205 may be further performed based on the first threshold signature policy.

In some embodiments, in this embodiment of the present disclosure, it may be further determined that the remote attestation fails when it is determined through remote attestation that the trusted execution environment is an insecure execution environment, or that the trusted execution environment is a secure execution environment but the key custody client is a non-trusted client. The first service terminal that integrates the resource management client may determine, when the remote attestation fails, that the key custody client is in an unavailable state, and further may notify the business service device to stop using the key custody client that is in the unavailable state to provide the key custody service. In this way, when the key custody client stops providing the key custody service (that is, a service fault occurs in the business service device), to ensure normal execution of service signing, in this embodiment of the present disclosure, a second threshold signature policy in the threshold signature policy may further be obtained (that is, multi-party threshold signature is implemented by using a plurality of service terminals (for example, the online key fragment stored in the first service terminal herein and the offline key fragment stored in the second service terminal) associated with the service object). In this case, in this embodiment of the present disclosure, the following operation S206 to operation S209 may be further performed based on the second threshold signature policy.

Operation S204: Obtain a first communication key by performing key exchange processing with the key custody client, and in response to the remote attestation succeeds, perform encryption processing on the object access data information by using the first communication key, to obtain object data encryption information.

Operation S205: Transmit, in response to obtaining a to-be-signed service transmitted by the service object, the object data encryption information and the to-be-signed service to the key custody client based on a first threshold signature policy corresponding to the to-be-signed service, so that the key custody client obtains the object access data information through decryption based on the first communication key, performs identity verification on the service object by using the object access data information, and when the identity verification succeeds, performs remote signing processing on the to-be-signed service by using a custodial key fragment stored in the key custody client, to obtain service remote signature information of the to-be-signed service.

Operation S206: Obtain a first key fragment of the service object based on the object access data information when the service remote signature information returned by the key custody client is received, and perform local signing processing on the to-be-signed service by using the first key fragment, to obtain service local signature information of the to-be-signed service.

Operation S207: Determine a first accumulated signature quantity of the to-be-signed service based on the service remote signature information and the service local signature information, and when the first accumulated signature quantity reaches an accumulated signature threshold indicated by the first threshold signature policy, use the to-be-signed service as a signed service to be written into a blockchain, and transmit the signed service to a blockchain node, wherein the signed service is written into the blockchain by the blockchain node into the blockchain.

For specific implementations of operation S204 to operation S207, reference may be made to the descriptions of operation S101 to operation S104 in the embodiment corresponding to FIG. 3, and details are not described herein again.

Operation S208: Determine that the key custody client is currently in an offline state when the remote attestation fails, and in response to obtaining a to-be-signed service transmitted by the service object, obtain a service signature data code of the to-be-signed service displayed on the second service terminal based on a second threshold signature policy corresponding to the to-be-signed service. The service signature data code is generated by the second service terminal for first-type signature information of the to-be-signed service; and the first-type signature information is obtained after the second service terminal performs first signing processing on the to-be-signed service by using the second key fragment.

Operation S209: Perform data parsing on the obtained service signature data code, to obtain the first-type signature information carried in the service signature data code.

Operation S210: Perform second signing processing on the to-be-signed service by using the first key fragment, to obtain second-type signature information of the to-be-signed service.

Operation S211: Determine a second accumulated signature quantity of the to-be-signed service based on the first-type signature information and the second-type signature information; and when the second accumulated signature quantity reaches an accumulated signature threshold indicated by the second threshold signature policy, use the to-be-signed service as a signed service to be written into the blockchain, and transmit the signed service to a blockchain node, wherein the signed service is written into the blockchain by the blockchain node into the blockchain.

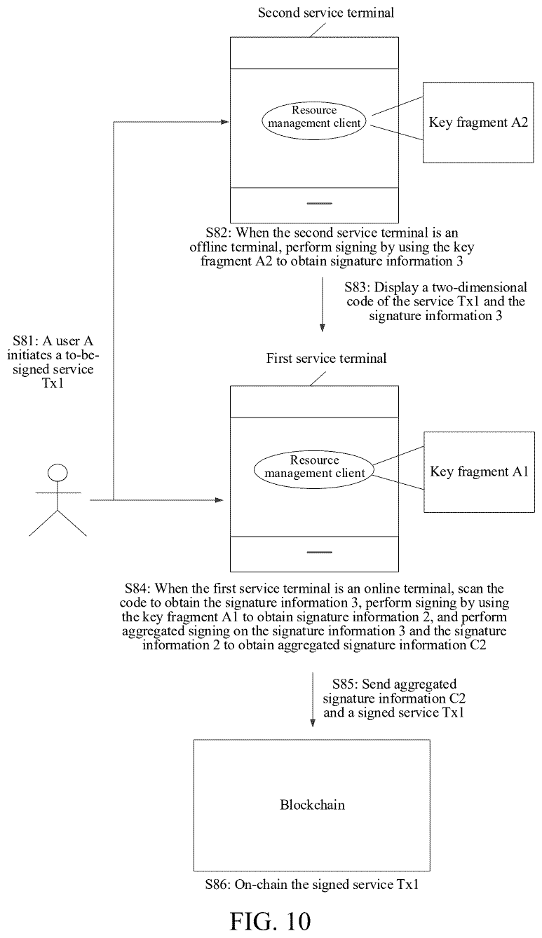

For ease of understanding, further, refer to FIG. 10, which is a schematic diagram of a scenario in which multi-party threshold signature is performed according to an embodiment of the present disclosure. As shown in FIG. 10, the first service terminal may perform multi-party threshold signature by using the first service terminal and the second service terminal shown in FIG. 10 when determining that a key custody client integrated in the business service device is unavailable because of a single point of failure of the business service device. The first service terminal herein may be the foregoing online terminal, and the second service terminal herein may be the foregoing offline terminal.

Specifically, as shown in FIG. 10, a user A may perform operation S81, to transmit a to-be-signed service Tx1 to the second service terminal shown in FIG. 10. At the same time, the first service terminal may also receive the service Tx1 initiated by the user A.

For the second service terminal currently serving as an offline terminal, when obtaining the service Tx1, operation S82 may be performed, to invoke an offline key fragment (that is, a second key fragment, for example, a key fragment A2 stored by a resource management client shown in FIG. 10) stored in the second service terminal to perform service signing on the service Tx1, and further, signature information 3 obtained by using service signing may be referred to as first-type signature information of the to-be-signed service.

Because the second service terminal is an offline terminal (that is, a user terminal not connected to a network), when obtaining signature information 3 (that is, first-type signature information) through signing, the second terminal may generate a service signature data code (for example, may generate a two-dimensional code carrying the service Tx1 and the signature information 3) of the service Tx1 based on the signature information 3 (that is, the first-type signature information). In this case, the second service terminal may further perform operation S83, to show the two-dimensional code of the service Tx1 and the signature information 3 to the first service terminal.

The first service terminal may perform operation S84. When the first service terminal is an online terminal, a camera function in the online terminal is invoked to perform code scanning processing on the two-dimensional code shown by the second service terminal, to scan to obtain the signature information 3 carried in the two-dimensional code. The first service terminal may also use the service Tx1 carried in the two-dimensional code obtained by code scanning as a to-be-compared service, and then perform service comparison between the to-be-compared service and the service Tx1 that is initiated by the user A and that is received by the first service terminal, and then ensure effectiveness and reliability of the signature information 3 (that is, the first-type signature information) transmitted by the second service terminal when the service comparison is “consistent”.

When performing operation S84, the first service terminal may perform signing processing on the received service Tx1 by using a key fragment A1 (that is, an online key fragment) stored by the resource management client, to obtain signature information 2 (that is, second-type signature information) shown in FIG. 10. The first service terminal may accumulate a signature quantity of the signature information (for example, the signature information 3 and the signature information 2) obtained by using the second threshold signature policy, and use the accumulated signature quantity as a second accumulated signature quantity of the to-be-signed service, so that when the second accumulated signature quantity reaches an accumulated signature threshold indicated by the second threshold signature policy, the service Tx1 may be used as a signed service to be written into a blockchain, and aggregated signing is performed on the signature information 3 and the signature information 2. Further, signature information obtained by aggregated signing may be collectively referred to as aggregated signature information (that is, second aggregated signature information, for example, aggregated signature information C2 shown in FIG. 10). The first service terminal may perform operation S85 by using the resource management client, and transmit the aggregated signature information C2 and the service Tx1 that is currently used as a signed service to a blockchain node, so that the blockchain node performs aggregated signature verification on the service Tx1 that is currently used as a signed service based on a global aggregated public key (that is, the foregoing global shared public key) carried in the second aggregated signature information, and writes, when the aggregated signature verification succeeds, the service Tx1 that is currently used as a signed service into a blockchain maintained by the blockchain node. The global aggregated public key (that is, the foregoing global shared public key) herein may be obtained by performing aggregated calculation on a public key carried in the first-type signature information and a public key carried in the second-type signature information. The global aggregated public key in the first aggregated signature information obtained through aggregation based on the first threshold signature policy is consistent with the global aggregated public key in the second aggregated signature information obtained through aggregation based on the second threshold signature policy. In other words, in this embodiment of the present disclosure, in a case that signing terminals participating in performing multi-party threshold signature includes the first service terminal, the second service terminal, and the business service device, the multi-party threshold signature may be implemented by using key fragments stored in any two terminal devices. Details are not described herein.

In some embodiments, in this embodiment of the present disclosure, a log recording client independent of the key custody client may be deployed in a trusted execution environment, and when the log recording client is a trusted client, and service remote signature information transmitted by the key custody client is obtained by using the log recording client, signature record flow information corresponding to the service remote signature information may be generated based on a log signature key of the log recording client, and the signature record flow information is added to a trusted log memory corresponding to the log recording client. In this way, the following operations may further be performed in this embodiment of the present disclosure: The first service terminal may obtain, from the trusted client review platform associated with the resource management client, a remote log review attestation report obtained after a plurality of review institutions perform task review on the log recording client, and generate a first signature query request based on the log signature key carried in the remote log review attestation report, the first signature query request being configured for performing signature query on the to-be-signed service. The first signature query request carries the log signature key. The first service terminal may transmit the first signature query request to the log recording client, so that the log recording client searches the trusted log memory for the signature record flow information based on the log signature key carried in the first signature query request. The first service terminal may transmit, by using the resource management client, a first search result returned by the log recording client; and determine, if the first search result indicates that the signature record flow information is found in the trusted log memory, that the key custody client participates in remote signing processing on the to-be-signed service according to the first threshold signature policy.

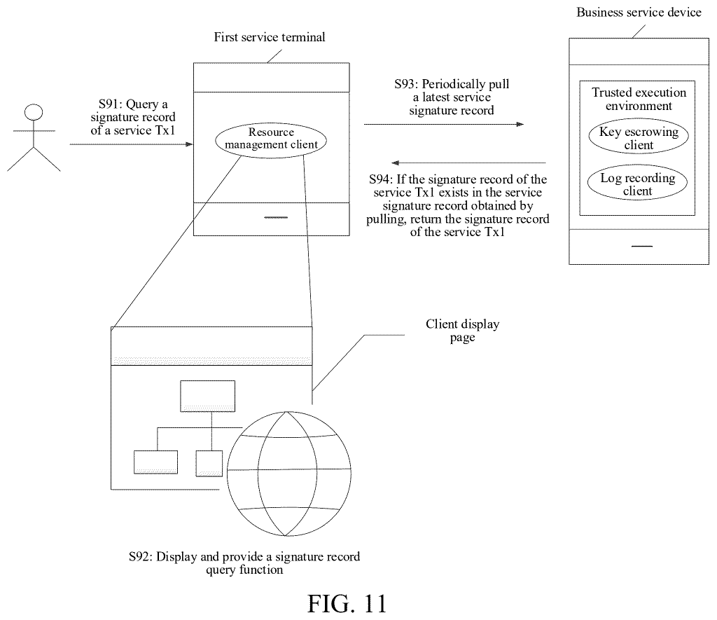

FIG. 11 is a schematic diagram of a scenario in which signature record flow information is searched for according to an embodiment of the present disclosure. As shown in FIG. 11, a service object (for example, the foregoing user A) may query a signature record of a service (for example, a service Tx1 shown in FIG. 11) by using a first service terminal when performing operation S91. In this case, when obtaining a signature record query request of the user A for the signature record of the service Tx1, the first service terminal may perform operation S92, to display and provide a signature record query function by using a client display page provided by a resource management client. In this case, the first service terminal may perform, by using the resource management client, remote attestation on a log recording client deployed in a trusted execution environment, and when the remote attestation succeeds, operation S93 shown in FIG. 11 is performed, to periodically pull, at regular intervals (for example, every 5 minutes), a latest service signature record from a business service device on which the log recording client is deployed. In this way, when the business service device returns a latest service signature record to the first service terminal, the first service terminal may further perform operation S94, that is, may query received service signature records for whether a signature record of the service Tx1 is stored, and if yes, may display the signature record of the service Tx1 on the client display page shown in FIG. 11.

In this embodiment of the present disclosure, the log recording client is deployed in the trusted execution environment, so that signature flows of all services may be permanently stored by using the log recording client in the trusted execution environment, so that signature information of these services stored in a trusted log memory of the log recording client may be subsequently used, thereby providing a possibility of proving its innocence to the third-party custodian. In this way, in a case that the user A holds two keys in a corresponding service terminal, even if a third-party custodian does not participate, service signing can still be independently completed. The threshold signature policy in this embodiment of the present disclosure may involve use of a threshold signature technology. By using the threshold signature technology, it can be ensured that none of devices (for example, an online device, an offline device, and a business service device) participating in key exchange processing can deduce a signing participant from a signature. Therefore, to prevent a phenomenon where a user may repudiate that a current service is conducted through collusive malicious acts between an custodian and a key thief to perform service signing on a service for user asset transfer, at this point, it is possible to use a log recording client deployed in a trusted execution environment to record a signature flow of each service signature. Thereby, the recorded signature flow of each service can help the third-party custodian achieve a possibility of proving its innocence.

In the embodiments of the present disclosure, on one hand, for the key custody client deployed in the foregoing embodiment related to FIG. 11, it may be ensured through authentication that only the user can use a local key fragment stored in the trusted enclave custody of the key custody client, that is, the third-party custodian does not have permission to invoke the local key fragment. On the other hand, for the log recording client deployed in the embodiment involved in FIG. 11, a service log may be perfected by using the log recording client, and a log function program corresponding to the log recording client needs to provide the following guarantee: 1) ensuring that each service signature is recorded; 2) ensuring that a service log of each service is never deleted; and 3) providing a query interface to ensure that a query result is returned for each query, where the query result herein may specifically include a recorded query result that no signature flow of a service exists and a recorded query result that a signature flow of a service exists.

To ensure application security of the log recording client in the trusted execution environment, this embodiment of the present disclosure may further continue to perform the following operations: The first service terminal may receive, when remote attestation is performed on the log recording client, a remote log attestation signature report transmitted by the local platform attestation signature component associated with the trusted execution environment. The first service terminal may obtain a log environment attestation report provided by the remote attestation server for the trusted execution environment, and determine that the trusted execution environment is a secure execution environment when it is determined, by using the log environment attestation report, that the remote log attestation signature report is a valid attestation report, and obtain, from a trusted client review platform associated with the resource management client, a remote log review attestation report obtained after a plurality of review institutions perform task review on the log recording client. The first service terminal may perform parameter comparison between a key report parameter in the remote log review attestation report and a key report parameter in the remote log attestation signature report, and determine that the log recording client is a trusted client deployed in the secure execution environment when the parameter comparison succeeds.

In this embodiment of the present disclosure, signature recording may be performed, by using a private key (that is, a log signature key) in a log signature key pair generated by the log recording client, on signature information generated by the key custody client, to obtain signature record flow information corresponding to the foregoing service remote signature information. The log signature key is generated in a trusted execution environment (that is, a TEE), and a public key of the log signature key pair is embodied in a remote attestation report for the log recording client. Therefore, in a case that a log function of the log recording client is completed in the TEE, and all operations provided by the log function are executed by secure, certain, and invariable code logic that is reviewed by a plurality of authoritative review institutions (for example, a plurality of review institutions selected in a one-time operation process), a phenomenon that a third-party custodian autonomously controls a query result can be effectively avoided; otherwise, whether the third-party custodian does not participate in signing, or does not provide a service log on purpose cannot be distinguished. In other words, security of an application program of a trusted application deployed in the TEE has been reviewed by different review institutions. Therefore, when a user repudiates that a service (for example, the foregoing service Tx1) is conducted through collusive malicious acts between a third-party custodian and a key thief, a forensic party can query the service logs recorded by the log recording client on the key custody device. If the service log for this service cannot be found, the third-party custodian did not participate in the signing. On the contrary, if the service log of the service can be found, and the user does not admit that the user participates in the signing, the user loses the user password for the user's own reason, and also loses a key fragment (for example, the foregoing first key fragment) configured for performing service signing. In this way, it is deduced reversely that this does not belong to responsibility of the third-party custodian, so that the third-party custodian can prove its innocence by using this method.

It can be seen that, in this embodiment of the present disclosure, key fragments (that is, local key fragments such as an online key fragment, an offline key fragment, and a custodial key fragment) are respectively deployed on different devices (for example, the online key fragment may be encrypted and stored on the first service terminal, the custodial key fragment may be stored on the business service device on which the trusted execution environment is deployed, and the offline key fragment may be stored on the second service terminal), so that security of key storage can be ensured. For example, in this embodiment of the present disclosure, it can be ensured that participants participating in key exchange processing by using the foregoing threshold signature policy cannot directly obtain another local key fragment other than the local key fragment stored therein, so that different threshold signature policies may be used according to actual requirements in a service signing process, to improve reliability of service signing. For example, in this embodiment of the present disclosure, the key custody client is deployed in the trusted execution environment, to resolve, from a root point, a problem of illegal leakage of a custodial key fragment caused by a loss of a key custody device held by a third-party custodian. In addition, in this embodiment of the present disclosure, by encrypting and storing the online key fragment, the first key fragment may also be prevented from being illegally leaked due to loss of a service terminal held by the user. Based on this, the first service terminal integrated with the resource management client involved in this embodiment of the present disclosure may determine, by using the resource management client when the threshold signature policy is the first threshold signature policy, whether an accumulated signature quantity (that is, a first accumulated signature quantity) of currently collected service signature information (for example, the service remote signature information and the service local signature information) reaches the accumulated signature threshold indicated by the first threshold signature policy, and may further use the to-be-signed service as a signed service to be written into the blockchain, and transmit the signed service to the blockchain node when the first accumulated signature quantity reaches the accumulated signature threshold indicated by the first threshold signature policy, wherein the signed service is written into the blockchain by the blockchain node into the blockchain, to ensure reliability of service on-chaining. In some embodiments, in this embodiment of the present disclosure, the offline key fragment is stored in the second service terminal independent of the first service terminal. In this way, when the key custody client configured to provide the key custody service is not available, multi-party threshold signature may further be performed by using the online key fragment stored in the first service terminal and the offline key fragment stored in the second service terminal, to ensure normal execution of service signing on the to-be-signed service.

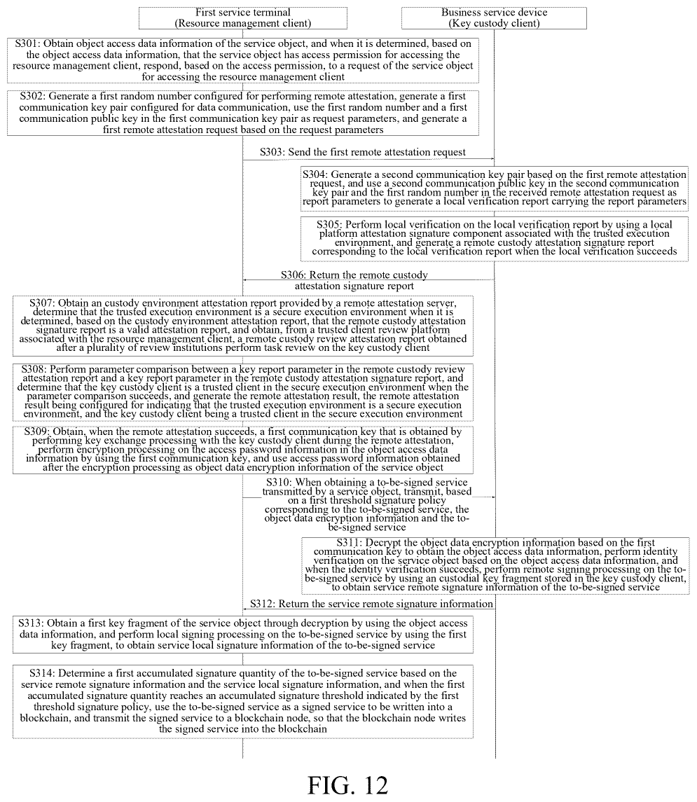

FIG. 12 is a process sequence diagram of a data processing method based on a trusted execution environment according to an embodiment of the present disclosure. As shown in FIG. 12, the method may be jointly performed by a first service terminal on which a resource management client is integrated and a business service device on which a trusted execution environment is deployed. The first service terminal herein may be the first service terminal 100b in the foregoing embodiment corresponding to FIG. 1, and the business service device herein may run, in the trusted execution environment, a key custody client configured to provide a key custody service. The business service device herein may be specifically any key custody device located in the business service cluster 100a in the embodiment corresponding to FIG. 1. As shown in FIG. 12, the method may at least include operation S301 to operation S314.

Operation S301: The first service terminal may obtain object access data information of the service object, and when it is determined, based on the object access data information, that the service object has access permission for accessing the resource management client, respond, based on the access permission, to a request of the service object for accessing the resource management client.

The object access data information includes access password information (for example, a service character string such as a user password) entered by the service object when accessing the resource management client. In one or more implementations, the object access data information may further include access biological feature information (for example, biological feature information such as face information or fingerprint information) other than the access password information (for example, a service character string such as a user password), and a specific type of the object access data information is not limited herein.

Operation S302: The first service terminal may generate a first random number configured for performing remote attestation, generate a first communication key pair configured for data communication, use the first random number and a first communication public key in the first communication key pair as request parameters, and generate a first remote attestation request based on the request parameters.

Operation S303: The first service terminal may transmit the first remote attestation request to the business service device on which a key custody client is integrated and running.

Operation S304: The key custody client in the business service device may generate a second communication key pair based on the first remote attestation request, and use a second communication public key in the second communication key pair and the first random number in the received remote attestation request as report parameters to generate a local verification report carrying the report parameters.

Operation S305: The key custody client in a business server may transmit, by using an ordinary application client in the business server, the local verification report to a local platform attestation signature component associated with the trusted execution environment, perform local verification on the local verification report by using the local platform attestation signature component associated with the trusted execution environment, and generate a remote custody attestation signature report corresponding to the local verification report when the local verification succeeds.

Operation S306: The local platform attestation signature component in the business server may return the remote custody attestation signature report to the first service terminal by using the ordinary application client.

In this way, the first service terminal may further perform the following operation S307 when receiving the remote custody attestation signature report returned by the local platform attestation signature component.

Operation S307: The first service terminal may obtain an custody environment attestation report provided by a remote attestation server, determine that the trusted execution environment is a secure execution environment when it is determined, based on the custody environment attestation report, that the remote custody attestation signature report is a valid attestation report, and obtain, from a trusted client review platform associated with the resource management client, a remote custody review attestation report obtained after a plurality of review institutions perform task review on the key custody client.

Operation S308: The first service terminal may perform parameter comparison between a key report parameter in the remote custody review attestation report and a key report parameter in the remote custody attestation signature report, and determine that the key custody client is a trusted client in the secure execution environment when the parameter comparison succeeds, and generate the remote attestation result, the remote attestation result being configured for indicating that the trusted execution environment is a secure execution environment, and the key custody client being a trusted client in the secure execution environment.

For the first service terminal, the first service terminal may determine that the remote attestation succeeds when the currently obtained remote attestation result indicates that the trusted execution environment deployed in the business service device is a secure execution environment, and the key custody client running on the business service device is a trusted client in the secure execution environment. Further, the following operation S309 may be performed when the remote attestation succeeds.

Operation S309: The first service terminal may obtain a first communication key by performing key exchange processing with the key custody client, and in response to the remote attestation succeeds, perform encryption processing on the object access data information by using the first communication key, to obtain object data encryption information.

Operation S310: When obtaining a to-be-signed service transmitted by a service object, the first service terminal may transmit, based on a first threshold signature policy corresponding to the to-be-signed service, the object data encryption information and the to-be-signed service to the business service device corresponding to the key custody client.

For the business service device, the business service device may receive the to-be-signed service and the object data encryption information that are transmitted, based on the first threshold signature policy corresponding to the to-be-signed service, by the first service terminal on which the resource management client runs.

Operation S311: The business service device may decrypt the object data encryption information based on the first communication key to obtain the object access data information, perform identity verification on the service object based on the object access data information, and when the identity verification succeeds, perform remote signing processing on the to-be-signed service by using a custodial key fragment stored in the key custody client, to obtain service remote signature information of the to-be-signed service.

Operation S312: The business service device may return the service remote signature information to the resource management client in the first service terminal by using the key custody client.

Operation S313: The first service terminal may obtain a first key fragment of the service object through decryption by using the object access data information when the service remote signature information returned by the key custody client is received, and perform local signing processing on the to-be-signed service by using the first key fragment, to obtain service local signature information of the to-be-signed service.

Operation S314: The first service terminal may determine a first accumulated signature quantity of the to-be-signed service based on the service remote signature information and the service local signature information, and when the first accumulated signature quantity reaches an accumulated signature threshold indicated by the first threshold signature policy, use the to-be-signed service as a signed service to be written into a blockchain, and transmit the signed service to a blockchain node, wherein the signed service is written into the blockchain by the blockchain node into the blockchain.

For specific implementations of operation S301 to operation S308, refer to a specific process description of remote attestation in the foregoing embodiment corresponding to FIG. 3. In addition, for specific implementations of operation S309 to operation S314, refer to the descriptions of operation S101 to operation S104 in the embodiment corresponding to FIG. 3, and details are not described herein again.

It can be seen that, in this embodiment of the present disclosure, key fragments (that is, local key fragments such as an online key fragment, an offline key fragment, and a custodial key fragment) are respectively deployed on different devices (for example, the online key fragment may be encrypted and stored on the first service terminal, the custodial key fragment may be stored on the business service device on which the trusted execution environment is deployed, and the offline key fragment may be stored on the second service terminal), so that security of key storage can be ensured. In this way, any participant participating in key exchange processing cannot directly perform reverse reasoning on another local key fragment stored in another device. Therefore, in a service signing process, different threshold signature policies may be used according to an actual requirement, to improve reliability of service signing. For example, in this embodiment of the present disclosure, by deploying the key custody client in the trusted execution environment, environment security of the trusted execution environment and application security of the key custody client deployed in the trusted execution environment may be ensured in a manner of performing remote attestation periodically or in real time, and a problem of illegal leakage of a custodial key fragment caused by a loss of a key custody device held by a third-party custodian may also be resolved from a root point. In addition, in this embodiment of the present disclosure, by encrypting and storing the online key fragment, the first key fragment may also be prevented from being illegally leaked due to loss of a service terminal held by the user. Based on this, the integrated resource management client involved in this embodiment of the present disclosure performs remote attestation on the key custody client deployed in the trusted execution environment, and after the remote attestation succeeds, multi-party threshold signature may be further performed by using the online key fragment in the first service terminal and the custodial key fragment in the business service device. That is, in this embodiment of the present disclosure, the first service terminal may determine, by using the resource management client when the threshold signature policy is the first threshold signature policy, whether an accumulated signature quantity (that is, a first accumulated signature quantity) of currently collected service signature information (for example, the service remote signature information and the service local signature information) reaches the accumulated signature threshold indicated by the first threshold signature policy, and may further use the to-be-signed service as a signed service to be written into the blockchain, and transmit the signed service to the blockchain node when the first accumulated signature quantity reaches the accumulated signature threshold indicated by the first threshold signature policy, wherein the signed service is written into the blockchain by the blockchain node into the blockchain, to ensure reliability of service on-chaining.

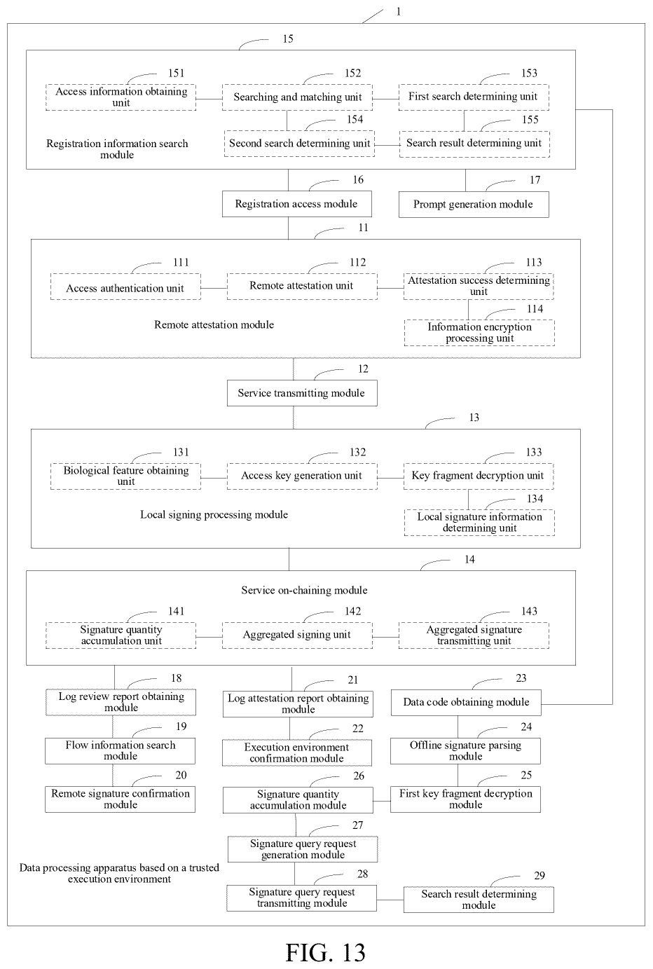

Further, FIG. 13 is a schematic structural diagram of a data processing apparatus based on a trusted execution environment according to the present disclosure. The data processing apparatus 1 based on a trusted execution environment may be a computer program (including program code) running in a computer device. For example, the data processing apparatus 1 based on a trusted execution environment is application software, and the data processing apparatus 1 based on a trusted execution environment may be configured to perform corresponding operations in the method provided in the embodiments of the present disclosure. As shown in FIG. 13, the data processing apparatus 1 based on a trusted execution environment may include a remote attestation module 11, a service transmitting module 12, a local signing processing module 13, and a service on-chaining module 14.

The remote attestation module 11 is configured to: perform remote attestation on a key custody client deployed in the trusted execution environment when a service object accesses the resource management client by using object access data information, obtain a first communication key by performing key exchange processing with the key custody client, and in response to the remote attestation succeeds, perform encryption processing on the object access data information by using the first communication key, to obtain object data encryption information;

the service transmitting module 12 is configured to transmit, in response to obtaining a to-be-signed service transmitted by the service object, the object data encryption information and the to-be-signed service to the key custody client based on a first threshold signature policy corresponding to the to-be-signed service, so that the key custody client obtains the object access data information through decryption based on the first communication key, performs identity verification on the service object by using the object access data information, and when the identity verification succeeds, performs remote signing processing on the to-be-signed service by using a custodial key fragment stored in the key custody client, to obtain service remote signature information of the to-be-signed service;

the local signing processing module 13 is configured to obtain a first key fragment of the service object based on the object access data information when the service remote signature information returned by the key custody client is received, and perform local signing processing on the to-be-signed service by using the first key fragment, to obtain service local signature information of the to-be-signed service; and

the service on-chaining module 14 is configured to: determine a first accumulated signature quantity of the to-be-signed service based on the service remote signature information and the service local signature information, and when the first accumulated signature quantity reaches an accumulated signature threshold indicated by the first threshold signature policy, use the to-be-signed service as a signed service to be written into a blockchain, and transmit the signed service to a blockchain node, wherein the signed service is written into the blockchain by the blockchain node into the blockchain.

For specific implementations of the remote attestation module 11, the service transmitting module 12, the local signing processing module 13, and the service on-chaining module 14, refer to the description of operation S101 to operation S104 in the foregoing embodiment corresponding to FIG. 3. Details are not described herein again.

In one embodiment, the apparatus 1 further includes: a registration information search module 15 and a registration access module 16.

The registration information search module 15 is configured to search, when object access data information entered by the service object is obtained, a registration service database associated with the resource management client for object registration data information matching the object access data information, to obtain a data information search result; and

the registration access module 16 determines that the service object is a registered object having access permission if the data information search result indicates that object registration data information matching the object access data information is found, and responds to a request of the service object for accessing the resource management client.

In one embodiment, the apparatus 1 further includes: a prompt generation module 17.

The prompt generation module 17 is configured to determine that the service object is an unregistered object if the data information search result indicates that no object registration data information matching the object access data information is found, and generate access failure prompt information.

For specific implementations of the registration information search module 15, the registration access module 16, and the prompt generation module 17, refer to a specific process description of accessing the resource management client in the foregoing embodiment corresponding to FIG. 3. Details are not further described herein.

The object registration data information includes registration password information and registration biological feature information that are entered by the service object when requesting to register with the resource management client; the data information search result includes an information search success result or an information search failure result; and

the registration information search module 15 includes: an access information obtaining unit 151, a searching and matching unit 152, a first search determining unit 153, a second search determining unit 154, and a search result determining unit 155.

The access information obtaining unit 151 is configured to obtain object access data information that is entered by the service object when requesting to access the resource management client; the object access data information including access password information and access biological feature information;

the searching and matching unit 152 is configured to search the registration service database associated with the resource management client for registration password information matching the access password information and search the registration service database for registration biological feature information matching the access biological feature information;

the first search determining unit 153 is configured to generate an information search success result if registration password information matching the access password information is found in the service database and registration biological feature information matching the access biological feature information is found;

the second search determining unit 154 is configured to generate an information search failure result if no registration password information matching the access password information is found in the service database, or no registration biological feature information matching the access biological feature information is found; and

the search result determining unit 155 is configured to use the information search success result or the information search failure result as the data information search result.

For specific implementations of the access information obtaining unit 151, the searching and matching unit 152, the first search determining unit 153, the second search determining unit 154, and the search result determining unit 155, refer to descriptions of a specific process of obtaining the data information search result in the foregoing embodiment corresponding to FIG. 3. Details are not described herein again.

The remote attestation module 11 includes: an access authentication unit 111, a remote attestation unit 112, an attestation success determining unit 113, and an information encryption processing unit 114.

The access authentication unit 111 is configured to: obtain object access data information of the service object, and when it is determined, based on the object access data information, that the service object has access permission for accessing the resource management client, respond, based on the access permission, to a request of the service object for accessing the resource management client. The object access data information includes access password information entered by the service object when accessing the resource management client.

The remote attestation unit 112 is configured to perform, by using the resource management client, remote attestation on the key custody client deployed in the trusted execution environment, to obtain a remote attestation result.

The attestation success determining unit 113 is configured to determine that the remote attestation succeeds when the remote attestation result indicates that the trusted execution environment is a secure execution environment, and the key custody client is a trusted client in the secure execution environment.

The information encryption processing unit 114 is configured to: obtain, when the remote attestation succeeds, a first communication key that is obtained by performing key exchange processing with the key custody client during the remote attestation, perform encryption processing on the access password information in the object access data information by using the first communication key, and use access password information obtained after the encryption processing as object data encryption information of the service object.

The object access data information includes access biological feature information entered by the service object when accessing the resource management client; and

the information encryption processing unit 114 is specifically configured to: perform encryption processing on the access biological feature information in the object access data information by using the first communication key, and use access biological feature information obtained after the encryption processing as the object data encryption information of the service object.

The remote attestation unit 112 is specifically configured to: generate a first random number configured for performing remote attestation, generate a first communication key pair configured for data communication, use the first random number and a first communication public key in the first communication key pair as request parameters, and generate a first remote attestation request based on the request parameters.

The remote attestation unit 112 is further specifically configured to: transmit the first remote attestation request to the key custody client, so that the key custody client generates a second communication key pair based on the first remote attestation request, and uses a second communication public key in the second communication key pair and the first random number in the received remote attestation request as report parameters to generate a local verification report carrying the report parameters; and the local verification report is configured for indicating a local platform attestation signature component associated with the trusted execution environment to perform local verification on the local verification report, and generate a remote custody attestation signature report corresponding to the local verification report when the local verification succeeds.

The remote attestation unit 112 is further specifically configured to: receive the remote custody attestation signature report returned by the local platform attestation signature component, obtain an custody environment attestation report provided by a remote attestation server, determine that the trusted execution environment is a secure execution environment when it is determined, based on the custody environment attestation report, that the remote custody attestation signature report is a valid attestation report, and obtain, from a trusted client review platform associated with the resource management client, a remote custody review attestation report obtained after a plurality of review institutions perform task review on the key custody client.

The remote attestation unit 112 is further specifically configured to perform parameter comparison between a key report parameter in the remote custody review attestation report and a key report parameter in the remote custody attestation signature report, and determine that the key custody client is a trusted client in the secure execution environment when the parameter comparison succeeds, and generate the remote attestation result, the remote attestation result being configured for indicating that the trusted execution environment is a secure execution environment, and the key custody client being a trusted client in the secure execution environment.

For specific implementations of the access authentication unit 111, the remote attestation unit 112, the attestation success determining unit 113, and the information encryption processing unit 114, refer to descriptions of a specific process of remote attestation in the foregoing embodiment corresponding to FIG. 3. Details are not further described herein.

A resource management memory of the resource management client stores a registration symmetric key and a first encryption key fragment corresponding to the first key fragment; the registration symmetric key is generated from registration biological feature information provided by the service object when registering with the resource management client; the first encryption key fragment is obtained after encryption processing is performed on the first key fragment by using the registration symmetric key when the service object is a registered object; and

the local signing processing module 13 includes: a biological feature obtaining unit 131, an access key generation unit 132, a key fragment decryption unit 133, and a local signature information determining unit 134.

The biological feature obtaining unit 131 is configured to obtain, from the object access data information according to an online fragment encryption policy in an object registration policy when the service remote signature information returned by the key custody client is received, access biological feature information provided by the service object when accessing the resource management client;

the access key generation unit 132 is configured to generate an access symmetric key by using the access biological feature information, and obtain the registration symmetric key and the first encryption key fragment from the resource management memory;

the key fragment decryption unit 133 is configured to: when it is determined that the registration symmetric key matches the access symmetric key, perform decryption processing on the first encryption key fragment by using the access symmetric key matching the registration symmetric key, to restore and obtain the first key fragment corresponding to the first encryption key fragment; and

the local signature information determining unit 134 is configured to perform local signing processing on the to-be-signed service by using the first key fragment, to obtain the service local signature information of the to-be-signed service.

For specific implementations of the biological feature obtaining unit 131, the access key generation unit 132, the key fragment decryption unit 133, and the local signature information determining unit 134, refer to descriptions of a specific process of obtaining the service local signature information in the foregoing embodiment corresponding to FIG. 3. Details are not further described herein.

The service on-chaining module 14 includes: a signature quantity accumulation unit 141, an aggregated signing unit 142, and an aggregated signature transmitting unit 143.

The signature quantity accumulation unit 141 is configured to accumulate signature quantities of the service remote signature information and the service local signature information based on the first threshold signature policy, to obtain a first accumulated signature quantity of the to-be-signed service;

the aggregated signing unit 142 is configured to perform aggregated signing on the service remote signature information and the service local signature information based on the first threshold signature policy when the first accumulated signature quantity reaches the accumulated signature threshold indicated by the first threshold signature policy, to obtain first aggregated signature information of the to-be-signed service, and use, based on the first aggregated signature information, the to-be-signed service as a signed service to be written into the blockchain; the first aggregated signature information carries a global aggregated public key; and

the aggregated signature transmitting unit 143 is configured to transmit the signed service and the first aggregated signature information to the blockchain node, so that the blockchain node performs aggregated signature verification on the signed service based on the global aggregated public key, and write, when the aggregated signature verification succeeds, the signed service into a blockchain maintained by the blockchain node; and the global aggregated public key is obtained by performing aggregated calculation on a public key carried in the remote signature information and a public key carried in the local signature information.

For specific implementations of the signature quantity accumulation unit 141, the aggregated signing unit 142, and the aggregated signature transmitting unit 143, refer to the foregoing description of a specific process of the aggregated signature in the embodiment corresponding to FIG. 3. Details are not described herein again.

In one embodiment, a log recording client independent of the key custody client is deployed in the trusted execution environment. When the log recording client is a trusted client, the log recording client is configured to: when the service remote signature information transmitted by the key custody client is obtained, generate signature record flow information corresponding to the service remote signature information based on a log signature key, and add the signature record flow information to a trusted log memory corresponding to the log recording client; and

the apparatus 1 further includes: a log review report obtaining module 18, a flow information search module 19, and a remote signature confirmation module 20.

The log review report obtaining module 18 is configured to obtain, from the trusted client review platform associated with the resource management client, a remote log review attestation report obtained after a plurality of review institutions perform task review on the log recording client, and generate a first signature query request based on the log signature key carried in the remote log review attestation report, the first signature query request being configured for performing signature query on the to-be-signed service; the first signature query request carries the log signature key;

the flow information search module 19 is configured to transmit the first signature query request to the log recording client, so that the log recording client searches the trusted log memory for the signature record flow information based on the log signature key carried in the first signature query request; and

the remote signature confirmation module 20 is configured to receive, by using the resource management client, a first search result returned by the log recording client, and determine, if the first search result indicates that the signature record flow information is found in the trusted log memory, that the key custody client participates in remote signing processing on the to-be-signed service according to the first threshold signature policy.

The apparatus 1 further includes: a log attestation report obtaining module 21 and an execution environment confirmation module 22.

The log attestation report obtaining module 21 is configured to receive, when remote attestation is performed on the log recording client, a remote log attestation signature report transmitted by the local platform attestation signature component associated with the trusted execution environment;

the execution environment determining module 22 is configured to: obtain a log environment attestation report provided by the remote attestation server for the trusted execution environment, and determine that the trusted execution environment is a secure execution environment when it is determined, by using the log environment attestation report, that the remote log attestation signature report is a valid attestation report, and obtain, from a trusted client review platform associated with the resource management client, a remote log review attestation report obtained after a plurality of review institutions perform task review on the log recording client; and

the execution environment determining module 22 is further configured to perform parameter comparison between a key report parameter in the remote log review attestation report and a key report parameter in the remote log attestation signature report, and determining that the log recording client is a trusted client deployed in the secure execution environment when the parameter comparison succeeds.

For specific implementations of the log attestation report obtaining module 21 and the execution environment confirmation module 22, refer to the foregoing description of a specific process of performing remote attestation by the log recording client in the embodiment corresponding to FIG. 8. Details are not further described herein.

In some embodiments, the resource management client is integrated and run on a first service terminal, and a service terminal associated with the service object includes a second service terminal; the second service terminal is an offline terminal independent of the first service terminal; the second service terminal is configured to record a second key fragment of the service object; and

the apparatus 1 further includes: a data code obtaining module 23, an offline signature parsing module 24, a first key fragment decryption module 25, and a signature quantity accumulation module 26.

The data code obtaining module 23 is configured to: determine that the key custody client is currently in an offline state when the remote attestation fails, and in response to obtaining a to-be-signed service transmitted by the service object, obtain a service signature data code of the to-be-signed service displayed on the second service terminal based on a second threshold signature policy corresponding to the to-be-signed service. The service signature data code is generated by the second service terminal for first-type signature information of the to-be-signed service; and the first-type signature information is obtained after the second service terminal performs first signing processing on the to-be-signed service by using the second key fragment.

The offline signature parsing module 24 is configured to perform data parsing on the obtained service signature data code, to obtain through parsing the first-type signature information carried in the service signature data code.

The first key fragment decryption module 25 is configured to perform, when the object access data information is configured for obtaining the first key fragment of the service object through decryption, second signing processing on the to-be-signed service by using the first key fragment, to obtain second-type signature information of the to-be-signed service; and

the signature quantity accumulation module 26 is configured to determine a second accumulated signature quantity of the to-be-signed service based on the first-type signature information and the second-type signature information; and when the second accumulated signature quantity reaches an accumulated signature threshold indicated by the second threshold signature policy, use the to-be-signed service as a signed service to be written into the blockchain, and transmit the signed service to a blockchain node, wherein the signed service is written into the blockchain by the blockchain node into the blockchain.

For specific implementations of the data code obtaining module 23, the offline signature parsing module 24, the first key fragment decryption module 25, and the signature quantity accumulation module 26, refer to descriptions of operation S208 to operation S211 in the foregoing embodiment corresponding to FIG. 8. Details are not further described herein.

In some embodiments, the apparatus 1 further includes: a signature query request generation module 27, a signature query request transmitting module 28, and a search result determining module 29.

The signature query request generation module 27 is configured to obtain, from a client review platform associated with the resource management client, a remote log review attestation report obtained after a plurality of review institutions perform task review on the log recording client, and generate a second signature query request based on the log signature key carried in the remote log review attestation report, the second signature query request being configured for requesting to perform signature query on the to-be-signed service; the second signature query request carries the log signature key;

the signature query request transmitting module 28 is configured to transmit the second signature query request to the log recording client, so that the log recording client searches the trusted log memory of the log recording client for signature record flow information of the to-be-signed service based on the log signature key carried in the signature query request; and

the search result determining module 29 is configured to receive, by using the resource management client, a second search result returned by the log recording client, and determine, if the second search result indicates that the signature record flow information is not found in the trusted log memory, that the key custody client does not participate in remote signing processing on the to-be-signed service according to the second threshold signature policy.

For specific implementations of the signature query request generation module 27, the signature query request transmitting module 28, and the search result determining module 29, refer to the description of a specific process of searching for the signature record flow information in the foregoing embodiment corresponding to FIG. 8. Details are not further described herein.

In one embodiment, before the service object accesses the resource management client by using the object access data information, the remote attestation module 11 is further configured to: perform, if the service object is an unregistered object, object registration on the resource management client by using object registration data information provided by the service object, and after the object registration data information is stored in the registration service database when the object registration succeeds, perform remote attestation on the key custody client deployed in the trusted execution environment by using the resource management client, and when the remote attestation succeeds, obtain a second communication key that is obtained by performing key exchange processing with the key custody client;

the remote attestation module 11 is further configured to perform encryption processing on registration password information in the object registration data information by using the second communication key, to obtain registration password encryption information corresponding to the registration password information; and

the remote attestation module 11 is further configured to transmit the registration password encryption information to the key custody client, so that the key custody client performs decryption processing on the registration key encryption information by using the second communication key that is obtained by performing key exchange processing with the resource management client, to restore and obtain the registration password information, and store the restored and obtained registration password information into a trusted enclave custody of the key custody client; and the registration password information stored in the trusted enclave custody of the key custody client being configured for performing remote information authentication on the access password information in the obtained object access data information, and authorizing the service object to invoke the custodial key fragment when the remote information authentication succeeds.

For a specific implementation of obtaining the registration password encryption information by using the remote attestation module 11, refer to the foregoing description of the registration password encryption information in the embodiment corresponding to FIG. 3. Details are not further described herein. In addition, the description of beneficial effects of the same method are not described herein again.

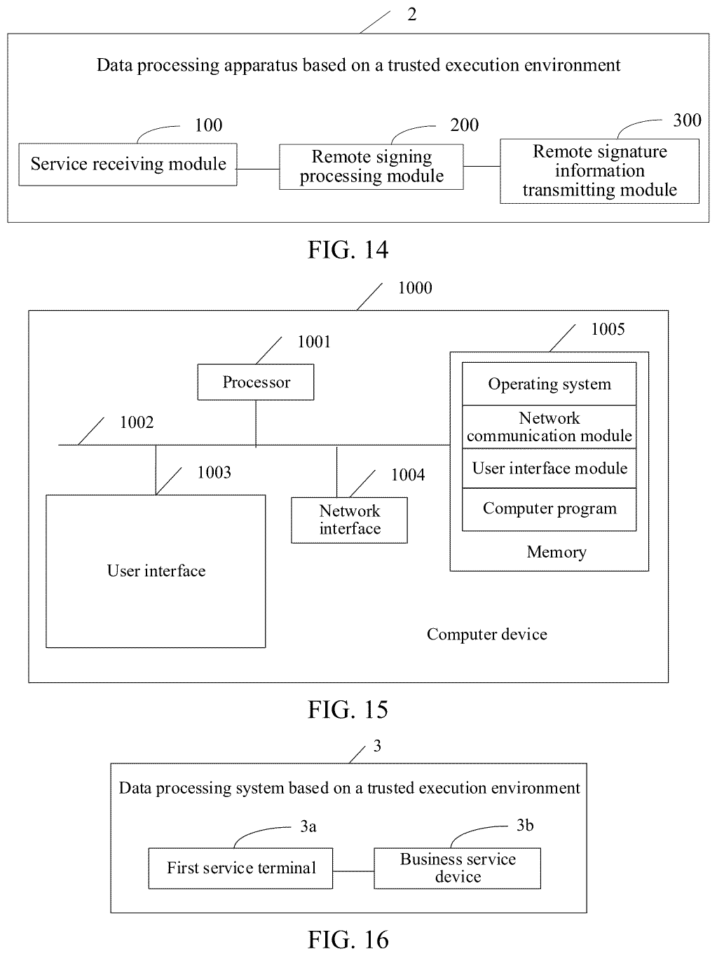

Further, FIG. 14 is a schematic structural diagram of a data processing apparatus based on a trusted execution environment according to the present disclosure. The data processing apparatus 2 based on a trusted execution environment may be a computer program (including program code) running in a computer device. For example, the data processing apparatus 2 based on a trusted execution environment is application software, and the data processing apparatus 2 based on a trusted execution environment may be configured to perform corresponding operations in the method provided in the embodiments of the present disclosure. As shown in FIG. 14, the data processing apparatus 2 based on a trusted execution environment may include: a service receiving module 100, a remote signing processing module 200, and a remote signature information transmitting module 300.

The service receiving module 100 is configured to receive a to-be-signed service and object data encryption information that is transmitted by a resource management client based on a first threshold signature policy corresponding to the to-be-signed service; the object data encryption information being obtained after the resource management client performs encryption processing on object access data information by using a first communication key; the first communication key being obtained by the resource management client by performing key exchange processing with the key custody client when the resource management client performs remote attestation on the key custody client deployed in the trusted execution environment and the remote attestation succeeds; and the object access data information being entered by a service object when accessing the resource management client;

the remote signing processing module 200 is configured to: decrypt the object data encryption information based on the first communication key to obtain the object access data information, perform identity verification on the service object based on the object access data information, and when the identity verification succeeds, perform remote signing processing on the to-be-signed service by using a custodial key fragment stored in the key custody client, to obtain service remote signature information of the to-be-signed service; and

the remote signature information transmitting module 300 is configured to transmit the service remote signature information to the resource management client, so that the resource management client obtains a first key fragment of the service object through decryption based on the object access data information, and performs local signing processing on the to-be-signed service by using the first key fragment, to obtain service local signature information of the to-be-signed service; and when the resource management client determines a first accumulated signature quantity of the to-be-signed service based on the service remote signature information and the service local signature information, and the first accumulated signature quantity reaches an accumulated signature threshold indicated by the first threshold signature policy, uses the to-be-signed service as a signed service to be written into a blockchain, and transmits the signed service to a blockchain node.

For specific implementations of the service receiving module 100, the remote signing processing module 200, and the remote signature information transmitting module 300, refer to the description of the business service device in the foregoing embodiment corresponding to FIG. 10. Details are not further described herein. In addition, the description of beneficial effects of the same method are not described herein again.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

FIG. 15 is a schematic structural diagram of a computer device according to the present disclosure. As shown in FIG. 15, a computer device 1000 may include: a processor 1001, a network interface 1004, and a memory 1005. In addition, the computer device 1000 may further include: a user interface 1003, and at least one communication bus 1002. The communication bus 1002 is configured to implement connection and communication between these components. In one embodiment, the user interface 1003 may further include a standard wired interface and wireless interface. In one embodiment, the network interface 1004 may include a standard wired interface and wireless interface (for example, a Wi-Fi interface). In some embodiments, the memory 1005 may be a high-speed RAM memory, or may be a non-volatile memory, for example, at least one magnetic disk memory. In some embodiments, the memory 1005 may alternatively be at least one storage apparatus away from the foregoing processor 1001. As shown in FIG. 15, the memory 1005 used as a computer-readable storage medium may include an operating system, a network communication module, a user interface module, and a device-control application program.

In the computer device 1000 shown in FIG. 15, the network interface 1004 may provide a network communication function. The user interface 1003 is mainly configured to provide an input interface for a user. The processor 1001 may be configured to invoke the device-control application program stored in the memory 1005 to implement the method in the foregoing embodiment corresponding to FIG. 3, FIG. 8, or FIG. 12. Details are not described herein again. In addition, the description of beneficial effects of the same method are not described herein again.

In addition, the present disclosure further provides a computer-readable storage medium, where the computer-readable storage medium stores a computer program executed by the foregoing data processing apparatus 1 based on a trusted execution environment or the foregoing data processing apparatus 2 based on a trusted execution environment, and the computer program includes program instructions. When a processor executes the program instructions, descriptions of the foregoing data processing method based on a trusted execution environment in the embodiment corresponding to FIG. 3, FIG. 8, or FIG. 12 can be executed. Therefore, details are not described herein again. In addition, the description of beneficial effects of the same method are not described herein again. For technical details that are not disclosed in the computer storage medium embodiments of the present disclosure, refer to the descriptions of the method embodiments of the present disclosure.

As an example, the program instructions may be deployed to be executed on a computer device, or deployed to be executed on a plurality of computer devices at one location, or deployed to be executed on a plurality of computer devices that are distributed in a plurality of locations and interconnected through a communication network. The plurality of computer devices that are distributed in the plurality of locations and interconnected through the communication network may form a blockchain consensus network.

The computer-readable storage medium may be a data processing apparatus for a blockchain or an internal storage unit of the foregoing computer device, for example, a hard drive or a memory of the computer device, provided in any one of the foregoing embodiments. The computer-readable storage medium may also be an external storage device of the computer device, such as a plug-in hard disk, a smart media card (SMC), a secure digital (SD) card, or a flash card equipped on the computer device. Further, the computer-readable storage medium may further include an internal storage unit of the computer device and an external storage device. The computer-readable storage medium is configured to store the computer program and other programs and data that are required by the computer device. The computer-readable storage medium may be further configured to temporarily store data that has been or is to be output.

In addition, an embodiment of the present disclosure provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device implements the foregoing descriptions of the data processing method based on a trusted execution environment in the embodiment corresponding to FIG. 3, FIG. 8, or FIG. 12. Details are not described herein again. In addition, the description of beneficial effects of the same method are not described herein again. For technical details that are not disclosed in the embodiments of the computer-readable storage medium included in the present disclosure, reference may be made to the descriptions about the method embodiments of the present disclosure.

Further, FIG. 16 is a schematic diagram of a data processing system based on a trusted execution environment according to an embodiment of the present disclosure. The data processing system 3 based on a trusted execution environment may include a first service terminal 3a and a business service device 3b. The first service terminal 3a may be the first service terminal 100b described in the embodiment corresponding to FIG. 1, and the business service device 3b may be any key custody device in the business service cluster 100a shown in FIG. 1. Details are not further described herein. In addition, the description of beneficial effects of the same method are not described herein again.

A person of ordinary skill in the art is to understand that all or a part of the processes of the method in the foregoing embodiment may be implemented by a program instructing relevant hardware. The program may be stored in a computer-readable storage medium. When the program is run, the processes of the method in the foregoing embodiment are performed. The foregoing storage medium may include a magnetic disc, an optical disc, a read-only memory (ROM), a random access memory (RAM), or the like.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method based on a trusted execution environment (TEE), wherein the method is performed by a resource management client, and the method comprises:
performing remote attestation on a key custody client deployed in the trusted execution environment when a service object accesses the resource management client by using object access data information, obtaining a first communication key by performing key exchange processing with the key custody client, and in response to the remote attestation succeeds, performing encryption processing on the object access data information by using the first communication key, to obtain object data encryption information;
transmitting, in response to obtaining a to-be-signed service transmitted by the service object, the object data encryption information and the to-be-signed service to the key custody client based on a first threshold signature policy corresponding to the to-be-signed service, so that the key custody client decrypts the object data encryption information by using the first communication key to obtain the object access data information, performs identity verification on the service object based on the object access data information, and when the identity verification succeeds, performs remote signing processing on the to-be-signed service by using a custodial key fragment stored in the key custody client, to obtain service remote signature information of the to-be-signed service;
obtaining a first key fragment of the service object based on the object access data information when the service remote signature information returned by the key custody client is received, and performing local signing processing on the to-be-signed service by using the first key fragment, to obtain service local signature information of the to-be-signed service; and
determining a first accumulated signature quantity of the to-be-signed service based on the service remote signature information and the service local signature information, and when the first accumulated signature quantity reaches an accumulated signature threshold indicated by the first threshold signature policy, using the to-be-signed service as a signed service to be written into a blockchain, and transmitting the signed service to a blockchain node, wherein the signed service is written into the blockchain by the blockchain node into the blockchain.

2. The method according to claim 1, wherein the method further comprises:
searching, when object access data information entered by the service object is obtained, a registration service database associated with the resource management client for object registration data information matching the object access data information, to obtain a data information search result; and
determining that the service object is a registered object having access permission in response to the data information search result indicating that object registration data information matching the object access data information is found, and responding to a request of the service object for accessing the resource management client.

3. The method according to claim 2, wherein the method further comprises:
determining that the service object is an unregistered object in response to the data information search result indicating that no object registration data information matching the object access data information is found, and generating access failure prompt information.

4. The method according to claim 2, wherein the object registration data information comprises registration password information and registration biological feature information that are entered by the service object when requesting to register with the resource management client; the data information search result comprises an information search success result or an information search failure result; and
the searching, when object access data information entered by the service object is obtained, a registration service database associated with the resource management client for object registration data information matching the object access data information, to obtain a data information search result comprises:
obtaining object access data information that is entered by the service object when requesting to access the resource management client, the object access data information comprising access password information and access biological feature information;
searching the registration service database for registration password information matching the access password information and searching the registration service database for registration biological feature information matching the access biological feature information;
generating the information search success result in response to that registration password information matching the access password information is found and registration biological feature information matching the access biological feature information is found; and
generating the information search failure result in response to that no registration password information matching the access password information is found, or no registration biological feature information matching the access biological feature information is found.

5. The method according to claim 1, wherein the performing remote attestation on a key custody client deployed in the trusted execution environment when a service object accesses the resource management client by using object access data information, obtaining a first communication key by performing key exchange processing with the key custody client, and in response to the remote attestation succeeds, performing encryption processing on the object access data information by using the first communication key, to obtain object data encryption information comprises:
obtaining object access data information of the service object, and when it is determined, based on the object access data information, that the service object has access permission for accessing the resource management client, responding, based on the access permission, to a request of the service object for accessing the resource management client; the object access data information comprising access password information entered by the service object when accessing the resource management client;
performing remote attestation on the key custody client deployed in the trusted execution environment, to obtain a remote attestation result;
determining that the remote attestation succeeds when the remote attestation result indicates that the trusted execution environment is a secure execution environment, and the key custody client is a trusted client in the secure execution environment; and
obtaining, when the remote attestation succeeds, a first communication key that is obtained by performing key exchange processing with the key custody client during the remote attestation, performing encryption processing on the access password information in the object access data information by using the first communication key, and using access password information obtained after the encryption processing as object data encryption information of the service object.

6. The method according to claim 5, wherein the object access data information comprises access biological feature information entered by the service object when accessing the resource management client; and
the performing encryption processing on the object access data information by using the first communication key, to obtain object data encryption information comprises:
performing encryption processing on the access biological feature information in the object access data information by using the first communication key, and using access biological feature information obtained after the encryption processing as the object data encryption information of the service object.

7. The method according to claim 5, wherein the performing remote attestation on the key custody client deployed in the trusted execution environment, to obtain a remote attestation result comprises:
generating a first random number configured for performing remote attestation, and generating a first communication key pair configured for data communication;
using the first random number and a first communication public key in the first communication key pair as request parameters to generate a first remote attestation request based on the request parameters;
transmitting the first remote attestation request to the key custody client, so that the key custody client generates a second communication key pair based on the first remote attestation request, and uses a second communication public key in the second communication key pair and the first random number in the received remote attestation request as report parameters to generate a local verification report carrying the report parameters; the local verification report being configured for indicating a local platform attestation signature component associated with the trusted execution environment to perform local verification on the local verification report, and generate a remote custody attestation signature report corresponding to the local verification report when the local verification succeeds;
receiving the remote custody attestation signature report returned by the local platform attestation signature component, obtaining an custody environment attestation report provided by a remote attestation server, and determining that the trusted execution environment is a secure execution environment when it is determined, based on the custody environment attestation report, that the remote custody attestation signature report is a valid attestation report;
obtaining, from a trusted client review platform associated with the resource management client, a remote custody review attestation report obtained after a plurality of review institutions perform task review on the key custody client; and performing parameter comparison between a key report parameter in the remote custody review attestation report and a key report parameter in the remote custody attestation signature report, and determining that the key custody client is a trusted client in the secure execution environment when the parameter comparison succeeds, and generating the remote attestation result, the remote attestation result being configured for indicating that the trusted execution environment is a secure execution environment, and the key custody client being a trusted client in the secure execution environment.

8. The method according to claim 1, wherein a resource management memory of the resource management client stores a registration symmetric key and a first encryption key fragment corresponding to the first key fragment; the registration symmetric key is generated from registration biological feature information provided by the service object when registering with the resource management client; the first encryption key fragment is obtained after encryption processing is performed on the first key fragment by using the registration symmetric key when the service object is a registered object; and
the obtaining a first key fragment of the service object based on the object access data information when the service remote signature information returned by the key custody client is received, and performing local signing processing on the to-be-signed service by using the first key fragment, to obtain service local signature information of the to-be-signed service comprises:
obtaining, from the object access data information according to an online fragment encryption policy in an object registration policy when the service remote signature information returned by the key custody client is received, access biological feature information provided by the service object when accessing the resource management client;
generating an access symmetric key by using the access biological feature information, and obtaining the registration symmetric key and the first encryption key fragment from the resource management memory;
performing decryption processing on the first encryption key fragment by using the access registration key when it is determined that the registration symmetric key matches the access symmetric key, to restore and obtain the first key fragment corresponding to the first encryption key fragment; and
performing local signing processing on the to-be-signed service by using the first key fragment, to obtain the service local signature information of the to-be-signed service.

9. The method according to claim 1, wherein the determining a first accumulated signature quantity of the to-be-signed service based on the service remote signature information and the service local signature information, and when the first accumulated signature quantity reaches an accumulated signature threshold indicated by the first threshold signature policy, using the to-be-signed service as a signed service to be written into a blockchain, and transmitting the signed service to a blockchain node comprises:
accumulating signature quantities of the service remote signature information and the service local signature information, to obtain the first accumulated signature quantity of the to-be-signed service;
performing aggregated signing on the service remote signature information and the service local signature information based on the first threshold signature policy when the first accumulated signature quantity reaches the accumulated signature threshold indicated by the first threshold signature policy, to obtain first aggregated signature information of the to-be-signed service, and using, based on the first aggregated signature information, the to-be-signed service as a signed service to be written into the blockchain; the first aggregated signature information carrying a global aggregated public key; and
transmitting the signed service and the first aggregated signature information to the blockchain node, so that the blockchain node performs aggregated signature verification on the signed service based on the global aggregated public key, and writes, when the aggregated signature verification succeeds, the signed service into a blockchain maintained by the blockchain node; the global aggregated public key being obtained by performing aggregated calculation on a public key carried in the service remote signature information and a public key carried in the service local signature information.

10. The method according to claim 1, wherein a log recording client is deployed in the trusted execution environment, and the log recording client and the key custody client are independent of each other; when the log recording client is a trusted client, the log recording client is configured to: when the service remote signature information transmitted by the key custody client is obtained, generate signature record flow information corresponding to the service remote signature information based on a log signature key, and add the signature record flow information to a trusted log memory corresponding to the log recording client; and
the method further comprises:
obtaining, from the trusted client review platform associated with the resource management client, a remote log review attestation report obtained after a plurality of review institutions perform task review on the log recording client, and generating a first signature query request based on the log signature key carried in the remote log review attestation report, the first signature query request being configured for performing signature query on the to-be-signed service; the first signature query request carrying the log signature key;
transmitting the first signature query request to the log recording client, so that the log recording client searches the trusted log memory for the signature record flow information based on the log signature key carried in the first signature query request;
receiving, by using the resource management client, a first search result returned by the log recording client; and determining, in response to the first search result indicating that the signature record flow information is found in the trusted log memory, that the key custody client participates in remote signing processing on the to-be-signed service according to the first threshold signature policy.

11. The method according to claim 10, wherein the method further comprises:
receiving, when remote attestation is performed on the log recording client, a remote log attestation signature report transmitted by the local platform attestation signature component associated with the trusted execution environment;
obtaining a log environment attestation report provided by the remote attestation server for the trusted execution environment, and determining that the trusted execution environment is a secure execution environment when it is determined, by using the log environment attestation report, that the remote log attestation signature report is a valid attestation report;
obtaining, from the trusted client review platform associated with the resource management client, a remote log review attestation report obtained after a plurality of review institutions perform task review on the log recording client; and
performing parameter comparison between a key report parameter in the remote log review attestation report and a key report parameter in the remote log attestation signature report, and determining that the log recording client is a trusted client deployed in the secure execution environment when the parameter comparison succeeds.

12. The method according to claim 1, wherein the resource management client is integrated and run on a first service terminal, and a service terminal associated with the service object comprises a second service terminal; the second service terminal is an offline terminal independent of the first service terminal; the second service terminal is configured to record a second key fragment of the service object; and
the method further comprises:
determining that the key custody client is currently in an offline state when the remote attestation fails, and in response to obtaining a to-be-signed service transmitted by the service object, obtaining a service signature data code of the to-be-signed service displayed on the second service terminal based on a second threshold signature policy corresponding to the to-be-signed service; the service signature data code being generated by the second service terminal for first-type signature information of the to-be-signed service; and the first-type signature information being obtained after the second service terminal performs first signing processing on the to-be-signed service by using the second key fragment;
performing data parsing on the obtained service signature data code, to obtain the first-type signature information carried in the service signature data code;
performing second signing processing on the to-be-signed service by using the first key fragment, to obtain second-type signature information of the to-be-signed service; and
determining a second accumulated signature quantity of the to-be-signed service based on the first-type signature information and the second-type signature information; and when the second accumulated signature quantity reaches an accumulated signature threshold indicated by the second threshold signature policy, using the to-be-signed service as a signed service to be written into the blockchain, and transmitting the signed service to a blockchain node, wherein the signed service is written into the blockchain by the blockchain node into the blockchain.

13. The method according to claim 12, wherein the method further comprises:
obtaining, from a client review platform associated with the resource management client, a remote log review attestation report obtained after a plurality of review institutions perform task review on the log recording client, and generating a second signature query request based on the log signature key carried in the remote log review attestation report, the second signature query request being configured for requesting to perform signature query on the to-be-signed service; the second signature query request carrying the log signature key;
transmitting the second signature query request to the log recording client, so that the log recording client searches the trusted log memory of the log recording client for signature record flow information of the to-be-signed service based on the log signature key carried in the signature query request;
receiving, by using the resource management client, a second search result returned by the log recording client; and determining, in response to the second search result indicating that the signature record flow information is not found in the trusted log memory, that the key custody client does not participate in remote signing processing on the to-be-signed service according to the second threshold signature policy.

14. The method according to claim 1, wherein the method further comprises:
performing, in response to that the service object is an unregistered object, object registration on the resource management client by using object registration data information provided by the service object, and after the object registration data information is stored in the registration service database when the object registration succeeds, performing remote attestation on the key custody client deployed in the trusted execution environment by using the resource management client, and when the remote attestation succeeds, obtaining a second communication key that is obtained by performing key exchange processing with the key custody client;
performing encryption processing on registration password information in the object registration data information by using the second communication key, to obtain registration password encryption information; and
transmitting the registration password encryption information to the key custody client, so that the key custody client performs decryption processing on the registration key encryption information by using the second communication key that is obtained by performing key exchange processing with the resource management client, to restore and obtain the registration password information, and store the restored and obtained registration password information into a trusted enclave custody of the key custody client; the registration password information stored in the trusted enclave custody of the key custody client being configured for performing remote information authentication on the access password information in the object access data information, and authorizing the service object to invoke the custodial key fragment when the remote information authentication succeeds.

15. A computer device, comprising a memory and a processor,
the memory being connected to the processor, the memory being configured to store a computer program, and the processor being configured to invoke the computer program to preform the method according to claim 1.

16. A data processing method based on a trusted execution environment, wherein the method is performed by a key custody client, the key custody client is deployed in the trusted execution environment, and the method comprises:
receiving a to-be-signed service and object data encryption information that is transmitted by a resource management client based on a first threshold signature policy corresponding to the to-be-signed service; the object data encryption information being obtained after the resource management client performs encryption processing on object access data information by using a first communication key; the first communication key being obtained by the resource management client by performing key exchange processing with the key custody client when the resource management client performs remote attestation on the key custody client and the remote attestation succeeds; and the object access data information being entered by a service object when accessing the resource management client;
decrypting the object data encryption information based on the first communication key to obtain the object access data information, performing identity verification on the service object based on the object access data information, and when the identity verification succeeds, performing remote signing processing on the to-be-signed service by using a custodial key fragment stored in the key custody client, to obtain service remote signature information of the to-be-signed service; and
transmitting the service remote signature information to the resource management client, so that the resource management client obtains a first key fragment of the service object based on the object access data information, and performs local signing processing on the to-be-signed service by using the first key fragment, to obtain service local signature information of the to-be-signed service; and when the resource management client determines a first accumulated signature quantity of the to-be-signed service based on the service remote signature information and the service local signature information, and the first accumulated signature quantity reaches an accumulated signature threshold indicated by the first threshold signature policy, uses the to-be-signed service as a signed service to be written into a blockchain, and transmits the signed service to a blockchain node.

17. A non-transitory computer-readable storage medium, the computer-readable storage medium storing a computer program, and the computer program being adapted to be loaded and executed by a processor of a resource management client, causing the processor to perform:
performing remote attestation on a key custody client deployed in a trusted execution environment when a service object accesses the resource management client by using object access data information, obtaining a first communication key by performing key exchange processing with the key custody client, and in response to the remote attestation succeeds, performing encryption processing on the object access data information by using the first communication key, to obtain object data encryption information;
transmitting, in response to obtaining a to-be-signed service transmitted by the service object, the object data encryption information and the to-be-signed service to the key custody client based on a first threshold signature policy corresponding to the to-be-signed service, so that the key custody client decrypts the object data encryption information by using the first communication key to obtain the object access data information, performs identity verification on the service object based on the object access data information, and when the identity verification succeeds, performs remote signing processing on the to-be-signed service by using a custodial key fragment stored in the key custody client, to obtain service remote signature information of the to-be-signed service;
obtaining a first key fragment of the service object based on the object access data information when the service remote signature information returned by the key custody client is received, and performing local signing processing on the to-be-signed service by using the first key fragment, to obtain service local signature information of the to-be-signed service; and
determining a first accumulated signature quantity of the to-be-signed service based on the service remote signature information and the service local signature information, and when the first accumulated signature quantity reaches an accumulated signature threshold indicated by the first threshold signature policy, using the to-be-signed service as a signed service to be written into a blockchain, and transmitting the signed service to a blockchain node, wherein the signed service is written into the blockchain by the blockchain node into the blockchain.

18. The storage medium according to claim 17, wherein the computer program further causes the processor to perform:
searching, when object access data information entered by the service object is obtained, a registration service database associated with the resource management client for object registration data information matching the object access data information, to obtain a data information search result; and
determining that the service object is a registered object having access permission in response to the data information search result indicating that object registration data information matching the object access data information is found, and responding to a request of the service object for accessing the resource management client.

19. The storage medium according to claim 18, wherein the method further comprises:
determining that the service object is an unregistered object in response to the data information search result indicating that no object registration data information matching the object access data information is found, and generating access failure prompt information.

20. The storage medium according to claim 18, wherein the object registration data information comprises registration password information and registration biological feature information that are entered by the service object when requesting to register with the resource management client; the data information search result comprises an information search success result or an information search failure result; and
the searching, when object access data information entered by the service object is obtained, a registration service database associated with the resource management client for object registration data information matching the object access data information, to obtain a data information search result comprises:
obtaining object access data information that is entered by the service object when requesting to access the resource management client, the object access data information comprising access password information and access biological feature information;
searching the registration service database for registration password information matching the access password information and searching the registration service database for registration biological feature information matching the access biological feature information;
generating the information search success result in response to that registration password information matching the access password information is found and registration biological feature information matching the access biological feature information is found; and
generating the information search failure result in response to that no registration password information matching the access password information is found, or no registration biological feature information matching the access biological feature information is found.
